(19) United States
(12) Patent Application Publication
(10) Pub. No.: US 2018/0196293 A1
(43) Pub. Date: Jul. 12, 2018

(54) IMAGE DISPLAY DEVICE

(71) Applicant: SHARP KABUSHIKI KAISHA, Sakai City, Osaka (JP)

(72) Inventor: KENTA FUKUOKA, Sakai City (JP)

(21) Appl. No.: 15/741,580

(22) PCT Filed: Jul. 22, 2016
(86) PCT No.: PCT/JP2016/071500

§ 371 Date: Jan. 3, 2018

(30) Foreign Application Priority Data
Jul. 29, 2015 (JP) 2015-149221

(51) Int. Cl. G02F 1/1347; G02B 27/26; G02B 5/30; G02F 1/1335

(52) U.S. Cl. CPC G02F 1/1347; G02B 27/26; G02F 1/133536; G02F 1/133514; G02B 5/3025

(57) ABSTRACT

Provided is a double display capable of displaying an image with a depth sensation, a three-dimensional sensation, and the like while securing sufficient transmittance of a panel on a front face side, without employing high speed drive such as a field sequential system. In an image display device that is provided with a first liquid crystal display unit (101) disposed on a front face side and including a first liquid crystal panel (11), a second liquid crystal display unit (102) disposed on a rear face side and including a second liquid crystal panel (12), and a backlight light source (30) disposed on the rear face side relative to the second liquid crystal display unit (102), a plurality of kinds of images (two kinds of images in general) are displayed in the second liquid crystal panel (12), and in the first liquid crystal panel (11), an image to be displayed is selected from the plurality of kinds of images on a pixel-by-pixel basis.

### TECHNICAL FIELD

The present invention relates to image display devices, and particularly relates to an image display device configured to display an image with a depth sensation, a three-dimensional sensation, and the like using two liquid crystal panels.

### BACKGROUND ART

Recently, such liquid crystal display devices have been developed that include not only a function to display images but also a transparent display function by which the background can be seen through. For example, JP 2010-91609 A discloses a structure of a transparent display in which the background is made non-transparent when an image is displayed, so that the displayed image is easy to be seen. FIG. 36 is a diagram illustrating a structure of a liquid crystal display device 800 including a transparent display function disclosed in JP 2010-91609 A. As illustrated in FIG. 36, the liquid crystal display device 800 includes a liquid crystal panel 810, a shutter film 820 provided on a rear face of the liquid crystal panel 810, a control unit 830 configured to control the drive of the liquid crystal panel 810 and the shutter film 820, a case 840, and a cylinder 850 as an observation target disposed inside the case 840. The shutter film 820 is a device capable of switching a state between a transparent state and a non-transparent state. When the shutter film 820 is in the transparent state, a viewer can see a rear side of the shutter film 820 through the liquid crystal panel 810. In other words, the viewer can see the cylinder 850 disposed on the rear side of the liquid crystal panel 810. Further, by setting the shutter film 820 in the non-transparent state, an image displayed on the liquid crystal panel 810 can be made easy to be seen by the viewer. A region of the shutter film 820 can be spatially divided into pieces of regions, and the states of the respective regions can be controlled separately as well.

As the liquid crystal display device including the transparent display function as discussed above, a liquid crystal display device of single screen display has mainly been developed thus far. However, in the case of the single screen display, improvement in expressiveness is limited. As such, in order that an image with a depth sensation, a three-dimensional sensation, and the like can be displayed, for example, it can be considered to use two liquid crystal panels and display two images being superimposed, thereby enhancing the expressiveness. Hereinafter, a display device having a structure in which two display surfaces (display panels such as liquid crystal panels) are superposed will be referred to as a “double display”. Description of such double display is disclosed, for example, in JP 2004-151186 A, JP 2009-86124 A, and the like.

### CITATION LIST

### Patent Literature

PTL 1: JP 2010-91609 A

PTL 2: JP 2004-151186 A

PTL 3: JP 2009-86124 A

### SUMMARY OF INVENTION

### Technical Problem

In a double display using two liquid crystal panels, in order to make a rear side of the liquid crystal panel on a front face side easy to be seen, transmittance of the liquid crystal panel on the front face side needs to be raised,

As such, it can be considered to employ a color filter-less liquid crystal panel for the liquid crystal panel on the front face side. In order to achieve color display with a structure using a color filter-less liquid crystal panel, the liquid crystal panel needs to be driven at high speed by a field sequential system. However, there exists difficulty achieving the desired color display due to the high speed drive or the like.

As such, an object of the present invention is to provide a double display capable of displaying an image with a depth sensation, a three-dimensional sensation, and the like while securing sufficient transmittance of a panel on a front face side, without employing high speed drive such as the field sequential system or the like.

### Solution to Problem

A first aspect of the present invention is an image display device including a first liquid crystal display unit disposed on a front face side and encompasses a first liquid crystal panel, a second liquid crystal display unit disposed on a rear face side and encompasses a second liquid crystal panel, and a backlight light source disposed on the rear face side relative to the second liquid crystal display unit,

wherein a plurality of kinds of images are displayed in the second liquid crystal panel, and

in the first liquid crystal panel, an image to be displayed is selected from the plurality of kinds of images on a pixel-by-pixel basis, or a display ratio is determined for each of the plurality of kinds of images.

A second aspect of the present invention is such that, in the first aspect of the present invention,

a first image and a second image, as the plurality of kinds of images, are alternately displayed temporally in the second liquid crystal panel, and

in the first liquid crystal panel, an applied voltage to each of the pixels is controlled so that a pixel to display the first image is set to an opened state while a pixel to display the second image is set to a closed state when the first image is displayed in the second liquid crystal panel, and so that a pixel to display the first image is set to the closed state while a pixel to display the second image is set to the opened state when the second image is displayed in the second liquid crystal panel.

A third aspect of the present invention is such that, in the second aspect of the present invention,

the first liquid crystal display unit includes the first liquid crystal panel and a first liquid crystal panel emission-side polarizing plate disposed on the front face side relative to the first liquid crystal panel, and

the second liquid crystal display unit includes the second liquid crystal panel, a second liquid crystal panel incidence-side polarizing plate disposed on the rear face side relative to the second liquid crystal panel, and a second liquid crystal panel emission-side polarizing plate disposed on the front face side relative to the second liquid crystal panel.

A fourth aspect of the present invention is such that, in the second aspect of the present invention,

the first liquid crystal display unit includes the first liquid crystal panel, a first liquid crystal panel incidence-side polarizing plate disposed on the rear face side relative to the first liquid crystal panel, and a first liquid crystal panel emission-side polarizing plate disposed on the front face side relative to the first liquid crystal panel, and

the second liquid crystal display unit includes the second liquid crystal panel, and a second liquid crystal panel incidence-side polarizing plate disposed on the rear face side relative to the second liquid crystal panel.

A fifth aspect of the present invention is such that, in the second aspect of the present invention,

the first liquid crystal display unit includes the first liquid crystal panel, a first liquid crystal panel incidence-side polarizing plate disposed on the rear face side relative to the first liquid crystal panel, and a first liquid crystal panel emission-side polarizing plate disposed on the front face side relative to the first liquid crystal panel, and

the second liquid crystal display unit includes the second liquid crystal panel, a second liquid crystal panel incidence-side polarizing plate disposed on the rear face side relative to the second liquid crystal panel, and a second liquid crystal panel emission-side polarizing plate disposed on the front face side relative to the second liquid crystal panel.

A sixth aspect of the present invention is such that, in any one of the third through fifth aspects of the present invention,

two λ/4 wavelength plates are further provided being arranged at a predetermined interval in a region between the first liquid crystal display unit and the second liquid crystal display unit.

A seventh aspect of the present invention is such that, in any one of the third through fifth aspects of the present invention,

a λ/2 wavelength plate is further provided in a region between the first liquid crystal display unit and the second liquid crystal display unit, and

in a case where a polarization direction of light emitted from the front face side of the second liquid crystal display unit is defined as a first direction, and a polarization direction of light incident on the first liquid crystal display unit when a desired image is displayed in the first liquid crystal display unit is defined as a second direction, an angle formed by the first direction and a slow axis direction of the λ/2 wavelength plate and an angle formed by the second direction and the slow axis direction of the λ/2 wavelength plate match each other.

An eighth aspect of the present invention is such that, in the fifth aspect of the present invention,

a double refraction film is further provided being arranged in a region between the first liquid crystal display unit and the second liquid crystal display unit,

A ninth aspect of the present invention is such that, in the first aspect of the present invention,

the first image and the second image, as the plurality of kinds of images, are alternately displayed spatially in the second liquid crystal panel,

the second liquid crystal display unit includes a polarization control element disposed on the front face side relative to the second liquid crystal panel, and sets a polarization state of light of the first image to a first polarization state and also sets a polarization state of light of the second image to a second polarization state, and

in the first liquid crystal panel, an applied voltage to each of the pixels is controlled so that a pixel to display the first image blocks the light in the second polarization state and allows the light in the first polarization state to pass through, and such that a pixel to display the second image blocks the light in the first polarization state and allow the light in the second polarization state to pass through.

A tenth aspect of the present invention is such that, in the ninth aspect of the present invention,

the polarization control element is a patterned polarizing plate including a structure in which two types of polarizing plates with transmittance axes orthogonal to each other are alternately disposed in striped form,

the first liquid crystal display unit includes the first liquid crystal panel and a first liquid crystal panel emission-side polarizing plate disposed on the front face side relative to the first liquid crystal panel, and

the second liquid crystal display unit includes the second liquid crystal panel, a second liquid crystal panel incidence-side polarizing plate disposed on the rear face side relative to the second liquid crystal panel, a second liquid crystal panel emission-side polarizing plate disposed on the front face side relative to the second liquid crystal panel, and the patterned polarizing plate disposed on the front face side relative to the second liquid crystal panel emission-side polarizing plate.

An eleventh aspect of the present invention is such that, in the ninth aspect of the present invention,

the polarization control element is a patterned wavelength plate including a structure in which two types of λ/2 wavelength plates with slow axes in mutually different directions are alternately disposed in striped form so that two types of light with polarization directions orthogonal to each other are alternately emitted in striped form,

the first liquid crystal display unit includes the first liquid crystal panel and a first liquid crystal panel emission-side polarizing plate disposed on the front face side relative to the first liquid crystal panel, and

the second liquid crystal display unit includes the second liquid crystal panel, a second liquid crystal panel incidence-side polarizing plate disposed on the rear face side relative to the second liquid crystal panel, a second liquid crystal panel emission-side polarizing plate disposed on the front face side relative to the second liquid crystal panel, and the patterned wavelength plate disposed on the front face side relative to the second liquid crystal panel emission-side polarizing plate.

A twelfth aspect of the present invention is such that, in the ninth aspect of the present invention,

the polarization control element causes light of the first image and light of the second image to be circularly polarized rotating in opposite directions to each other.

A thirteenth aspect of the present invention is such that, in the twelfth aspect of the present invention,

the polarization control element is a patterned wavelength plate including a structure in which two types of λ/4 wavelength plates with slow axes in mutually different directions are alternately disposed in striped form so that right handed circularly-polarized light and left handed circularly-polarized light are alternately emitted in striped form,

the first liquid crystal display unit is constituted of the first liquid crystal panel, a λ/4 wavelength plate disposed on the rear face side relative to the first liquid crystal panel and including a slow axis in the same direction as the slow axis of one of the above two types of λ/4 wavelength plates, and a first liquid crystal panel emission-side polarizing plate disposed on the front face side relative to the first liquid crystal panel, and

the second liquid crystal display unit is constituted of the second liquid crystal panel, a second liquid crystal panel incidence-side polarizing plate disposed on the rear face side relative to the second liquid crystal panel, a second liquid crystal panel emission-side polarizing plate disposed on the froth face side relative to the second liquid crystal panel, and the patterned wavelength plate disposed on the front face side relative to the second liquid crystal panel emission-side polarizing plate.

A fourteenth aspect of the present invention is such that, in the twelfth aspect of the present invention,

the polarization control element is a patterned wavelength plate including a structure in which two types of λ/4 wavelength plates with slow axes in mutually different directions are alternately disposed in striped form such that right handed circularly-polarized light and left handed circularly-polarized light are alternately emitted in striped form,

the first liquid crystal display unit includes the first liquid crystal panel and a first liquid crystal panel emission-side polarizing plate disposed on the front face side relative to the first liquid crystal panel,

the second liquid crystal display unit includes the second liquid crystal panel, a second liquid crystal panel incidence-side polarizing plate disposed on the rear face side relative to the second liquid crystal panel, a second liquid crystal panel emission-side polarizing plate disposed on the froth face side relative to the second liquid crystal panel, and the patterned wavelength plate disposed on the front face side relative to the second liquid crystal panel emission-side polarizing plate, and

the first liquid crystal panel functions as a variable wavelength plate configured to control the slow axis direction by the applied voltage on a pixel-by-pixel basis.

A fifteenth aspect of the present invention is such that, in the first aspect of the present invention,

of the first liquid crystal panel and the second liquid crystal panel, only the second liquid crystal panel includes a color filter.

### Advantageous Effects of Invention

According to the first aspect of the present invention, a plurality of kinds of images are displayed in the second liquid crystal panel disposed on the rear face side, and in the first liquid crystal panel disposed on the front face side, an image to he displayed is selected on a pixel-by-pixel basis (or the display ratio is determined). A color filter-less liquid crystal panel can he employed as the first liquid crystal panel because it is only required to carry out action to select the image (or action to adjust the display ratio) in the first liquid crystal panel. With this, the transmittance of the liquid crystal panel on the front face side (first liquid crystal panel) can be increased. Therefore, in a double display using two liquid crystal panels, the rear side of the liquid crystal panel on the front face side can be made easy to be seen. Here, it can be thought of that an image displayed in a small area (e.g. a character image) in the liquid crystal panel on the front face side (first liquid crystal panel) can he visually recognized, by a viewer, as being displayed on a front face side relative to the peripheral image. By taking this point into consideration, an image with a depth sensation, a three-dimensional sensation, and the like can be displayed. As discussed above, the double display capable of displaying an image with a depth sensation, a three-dimensional sensation, and the like can be provided while securing sufficient transmittance of the panel on the front face side.

According to the second aspect of the present invention, it is sufficient that the drive is carried out at twice the regular drive speed taking 60 Hz as a drive frequency, so as to switch the two kinds of images at each frame. As such, the double display capable of displaying an image with a depth sensation, a three-dimensional sensation, and the like can be provided while securing sufficient transmittance of the panel on the front face side, without employing high speed drive such as a field sequential system.

According to the third aspect of the present invention, in addition to obtaining the same effect as that of the second aspect of the present invention, an effect of improvement in light utilization efficiency, transmittance, and the like is obtained because components of light absorbed or reflected by the polarizing plates are lessened. Further, because the number of necessary polarizing plates becomes smaller than before, an effect of reduction in manufacturing cost is obtained.

According to the fourth aspect of the present invention, in addition to obtaining the same effect as that of the second aspect of the present invention, an effect of improvement in light utilization efficiency, transmittance, and the like is obtained because components of light absorbed or reflected by the polarizing plates are lessened. Further, because the number of necessary polarizing plates becomes less than before, an effect of reduction in manufacturing cost is obtained. Furthermore, because a polarizing plate (the first liquid crystal panel incidence-side polarizing plate) is provided on the rear face side of the first liquid crystal panel, when an object is placed between the first liquid crystal display unit and the second liquid crystal display unit, the stated object can be blocked.

According to the fifth aspect of the present invention, in addition to obtaining the same effect as that of the second aspect of the present invention, an effect of improvement in contrast is obtained because polarizing plates are provided on both the rear face side of the first liquid crystal panel and the front face side of the second liquid crystal panel. Further, when an object is placed between the first liquid crystal display unit and the second liquid crystal display unit, the stated object can be blocked.

According to the sixth aspect of the present invention, two λ/4 wavelength plates are provided between the first liquid crystal display unit and the second liquid crystal display unite Here, by arranging one of the λ/4 wavelength plates near the first liquid crystal display unit and arranging the other one of the λ/4 wavelength plates near the second liquid crystal display unit, influence of surface reflection generated in a space between the first liquid crystal display unit and the second liquid crystal display unit upon display can be reduced. In this manner, the influence of surface reflection of light upon display can be reduced. When an emission polarization direction associated with the second liquid crystal display unit and an incidence polarization direction associated with the first liquid crystal display unit are orthogonal to each other, the polarization direction of emission light from the second liquid crystal display unit can be matched, after the emission light passing through the two λ/4 wavelength plates, with the incidence polarization direction associated with the first liquid crystal display unit.

According to the seventh aspect of the present invention, regardless of a relationship between the emission polarization direction associated with the second liquid crystal display unit and the incidence polarization direction associated with the first liquid crystal display unit, in a case where the respective polarization directions (the emission polarization direction and incidence polarization direction) are known, the polarization direction of emission light from the second liquid crystal display unit can be matched, after the emission light passing through the λ/2 wavelength plate, with the incidence polarization direction associated with the first liquid crystal display unit by arranging the λ/2 wavelength plate with appropriate orientation.

According to the eighth aspect of the present invention, a double refraction film is provided between the second liquid crystal display unit and the first liquid crystal display unit. Because of this, the light supplied to the first liquid crystal display unit from the second liquid crystal display unit certainly contains components vibrating in the same direction as the incidence polarization direction associated with the first liquid crystal display unit. This makes it possible to see the display by the second liquid crystal display unit from the front face side of the first liquid crystal display unit, regardless of the relationship between the emission polarization direction associated with the second liquid crystal display unit and the incidence polarization direction associated with the first liquid crystal display unit. Further, even in a case where the relationship between the emission polarization direction associated with the second liquid crystal display unit and the incidence polarization direction associated with the first liquid crystal display unit is not determined at the design time, the display by the second liquid crystal display unit can be seen from the front face side of the first liquid crystal display unit.

According to the ninth aspect of the present invention, since the structure in which two kinds of images are alternately displayed spatially is employed, the regular drive taking 60 Hz as a drive frequency can be employed. Because of this, generation of crosstalk (a phenomenon in which two kinds of images are mixed) can be suppressed. As discussed above, it is possible to provide a double display capable of suppressing generation of crosstalk and displaying an image with a depth sensation, a three-dimensional sensation, and the like while securing sufficient transmittance of the panel on the front face side, without employing high speed drive such as a field sequential system or the like.

According to the tenth aspect of the present invention, in addition to obtaining the same effect as that of the ninth aspect of the present invention, an effect of improvement in light utilization efficiency, transmittance, and the like is obtained because components of light absorbed or reflected by the polarizing plates are lessened. Further, because the number of necessary polarizing plates becomes smaller than before, an effect of reduction in manufacturing cost is obtained.

According to the eleventh aspect of the present invention, in addition to obtaining the same effect as that of the tenth aspect of the present invention, utilization efficiency of the emission light from the second liquid crystal panel can be further enhanced.

According to the twelfth aspect of the present invention, in addition to obtaining the same effect as that of the ninth aspect of the present invention, the influence of surface reflection generated in a space between the first liquid crystal display unit and the second liquid crystal display unit upon display can be reduced because the light emitted from the second liquid crystal display unit toward the first liquid crystal display unit is circularly polarized.

According to the thirteenth aspect of the present invention, the same effect as that of the twelfth aspect of the present invention is obtained. In a case where an object is disposed between the first liquid crystal display unit and the second liquid crystal display unit, there is a possibility that the object cannot be seen. However, by employing a structure in which a light source to radiate light toward a space between the first liquid crystal display unit and the second liquid crystal display unit, emission light from the light source is not blocked. With this, in the case where an object is disposed between the first liquid crystal display unit and the second liquid crystal display unit, it is possible for a viewer to see the stated object.

According to the fourteenth aspect of the present invention, the same effect as that of the thirteenth aspect of the present invention can be obtained with an image display device having a relatively simple structure.

According to the fifteenth aspect of the present invention, a color filter is not provided in the first liquid crystal panel. This makes it possible to increase the transmittance of the liquid crystal panel on the front face side (the first liquid crystal panel) with certainty. With this, in the double display using two liquid crystal panels, the rear side of the liquid crystal panel on the front face side can be made easy to be seen.

### BRIEF DESCRIPTION OF DRAWINGS

FIG. 1 is a diagram that is related to the structure of an image display device, and describes a common structure to all the embodiments of the present invention.

FIG. 2 is a diagram for describing a first method (a method in which an active shutter system of 3D display technique is applied).

FIG. 3 is a diagram for describing a second method (a method in which a passive system of 3D display technique is applied).

FIG. 4 is a diagram illustrating a structure of an image display device according to a first embodiment of the present invention.

FIG. 5 is a diagram for describing action of the image display device in the first embodiment.

FIG. 6 is a diagram for describing the action of the image display device in the first embodiment.

FIG. 7 is a diagram for describing the action of the image display device in the first embodiment.

FIG. 8 is a diagram for describing the action of the image display device in the first embodiment.

FIG. 9 is a diagram for describing the action of the image display device in the first embodiment.

FIG. 10 is a diagram for describing the action of the image display device in the first embodiment.

FIG. 11 is a diagram for describing a case where an object is placed between a first liquid crystal display unit and a second liquid crystal display unit in the first embodiment.

FIG. 12 is a diagram illustrating a structure of an image display device according to a second embodiment of the present invention.

FIG. 13 is a diagram illustrating a structure of an image display device according to a third embodiment of the present invention.

FIG. 14 is a diagram illustrating a structure of an image display device according to a fourth embodiment of the present invention.

FIG. 15 is a diagram for describing how to dispose a λ/4 wavelength plate in a case where an emission polarization direction associated with a second liquid crystal display unit matches an incidence polarization direction associated with a first liquid crystal display unit in the fourth embodiment.

FIG. 16 is a diagram for describing how to dispose the λ/4 wavelength plate in a case where the emission polarization direction associated with the second liquid crystal display unit, is orthogonal to the incidence polarization direction associated with the first liquid crystal display unit in the fourth embodiment,

FIG. 17 is a diagram illustrating a structure of an image display device according to a fifth embodiment of the present invention.

FIG. 18 is a diagram for describing how to dispose a λ/2 wavelength plate in the fifth embodiment.

FIG. 19 is a diagram for describing how to dispose the λ/2 wavelength plate in the fifth embodiment.

FIG. 20 is a diagram illustrating a structure of an image display device according to a sixth embodiment of the present invention.

FIG. 21 is a diagram for describing how to dispose a double refraction film in the sixth embodiment.

FIG. 22 is a diagram for describing how to dispose the double refraction film in the sixth embodiment.

FIG. 23 is a diagram illustrating a structure of an image display device according to a seventh embodiment of the present invention.

FIG. 24 is a diagram for describing a structure of a patterned polarizer in the seventh embodiment.

FIG. 25 is a diagram for describing the structure of the patterned polarizer in the seventh embodiment.

FIG. 26 is a diagram for describing display in a second liquid crystal panel in the seventh embodiment.

FIG. 27 is a diagram for describing incident light on the patterned polarizer and emission light from the patterned polarizer in the seventh embodiment.

FIG. 28 is a diagram illustrating a structure of an image display device according to an eighth embodiment of the present invention.

FIG. 29 is a diagram for describing how light travels through a patterned retarder in the eighth embodiment.

FIG. 30 is a diagram illustrating a structure of an image display device according to a ninth embodiment of the present invention.

FIG. 31 is a diagram for describing how light travels through a patterned retarder and a λ/4 wavelength plate in the ninth embodiment.

FIG. 32 is a diagram for describing an effect in the ninth embodiment.

FIG. 33 is a diagram illustrating a structure of an image display device according to a tenth embodiment of the present invention.

FIG. 34 is a diagram for describing how light travels through a patterned retarder and a first liquid crystal panel (active retarder) in the tenth embodiment.

FIG. 35 is a diagram for describing how light travels through the patterned retarder and the first liquid crystal panel (active retarder) in the tenth embodiment.

FIG. 36 is a diagram illustrating a structure of a liquid crystal display device including a transparent display function disclosed in JP 2010-91609 A.

### DESCRIPTION OF EMBODIMENT

### 0. Introduction

Before describing respective embodiments of the present invention, a structure common to all the embodiments and an outline of action of an image display device according to the present invention will be described.

### 0.1 Common Structure to All Embodiments

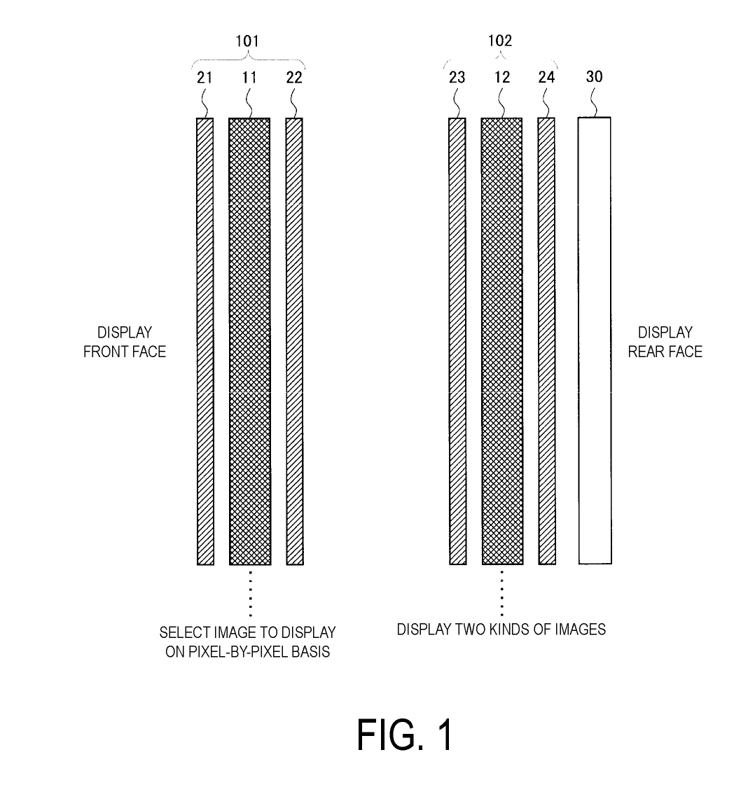

FIG. 1 is a diagram that is related to the structure of an image display device, and describes a common structure to all the embodiments of the present invention. The image display device according to the present invention is constituted of two liquid crystal display units 101 and 102, and a backlight light source 30. Hereinafter, the liquid crystal display unit 101 disposed on a display front face side (a side from which a viewer sees the screen) is referred to as a “first liquid crystal display unit”, while the liquid crystal display unit 102 disposed on a display rear face side is referred to as a “second liquid crystal display unit”.

In the first liquid crystal display unit 101, a polarizing plate 21, a liquid crystal panel 11, and a polarizing plate 22 are provided in that order from the display front face side toward the display rear face side. In the second liquid crystal display unit 102, a polarizing plate 23, a liquid crystal panel 12, and a polarizing plate 24 are provided in that order from the display front face side toward the display rear face side. However, it is not absolutely necessary for one of the polarizing plate 22 and the polarizing plate 23 to be provided. The liquid crystal panel 12 is a typical liquid crystal panel including a color filter, while the liquid crystal panel 11 is a color filter-less liquid crystal panel. The backlight light source 30 is provided on a rear face side of the second liquid crystal display unit 102. A relationship between the size of a pixel of the liquid crystal panel 11 and the size of a pixel of the liquid crystal panel 12 is not limited to any specific one. Hereinafter, the liquid crystal panel 11 will be referred to as a “first liquid crystal panel”, the polarizing plate 21 will be referred to as a “first liquid crystal panel emission-side polarizing plate”, and the polarizing plate 22 will be referred to as a “first liquid crystal panel incidence-side polarizing plate”. Further, the liquid crystal panel 12 will be referred to as a “second liquid crystal panel”, the polarizing plate 23 will be referred to as a “second liquid crystal panel emission-side polarizing plate”, and the polarizing plate 24 will be referred to as a “second liquid crystal panel incidence-side polarizing plate”.

As will be described later, only in a tenth embodiment, different from first through ninth embodiments, a panel capable of functioning as an active retarder (a λ/4 wavelength plate capable of controlling a slow axis direction by an applied voltage for each pixel) is used for the first liquid crystal panel.

### 0.2 Outline of Action of Image Display Device According to Present Invention

In the image display device with the structure as discussed above, image display is carried out by a 3D display (three-dimensional display) technique being applied. In general, a plurality of kinds of images (typically, two kinds of images) are displayed in the second liquid crystal panel 12; of the plurality of kinds of images, an image to be displayed on the display front face is selected in the first liquid crystal panel 11 on a pixel-by-pixel basis. With this, a combined image that looks, to a viewer, as if the plurality of kinds of images are superimposed is displayed on the display front face. As methods for achieving such display, two methods (a first method and a second method) can be cited. The first method is a method in which an active shutter system of 3D display technique is applied. The second method is a method in which a passive system of 3D display technique is applied. The first method is employed in the first through sixth embodiments, and the second method is employed in the seventh through tenth embodiments.

### 0.2.1 First Method

In a 3D liquid crystal display device (three-dimensional liquid crystal display device) employing the active shutter system, an image for the left eye and an image for the right eye are alternately displayed by time-division at high speed. In synchronization with the image for the left eye and the image for the right eye being alternately displayed, a lens for the left eye and a lens for the right eye of active shutter glasses worn by a viewer are alternately switched to an opened state (a state in which light is allowed to pass through). With this, the left eye sees only the image for the left eye and the right eye sees only the image for the right eye. As a result, a three-dimensional image is visually recognized by the viewer.

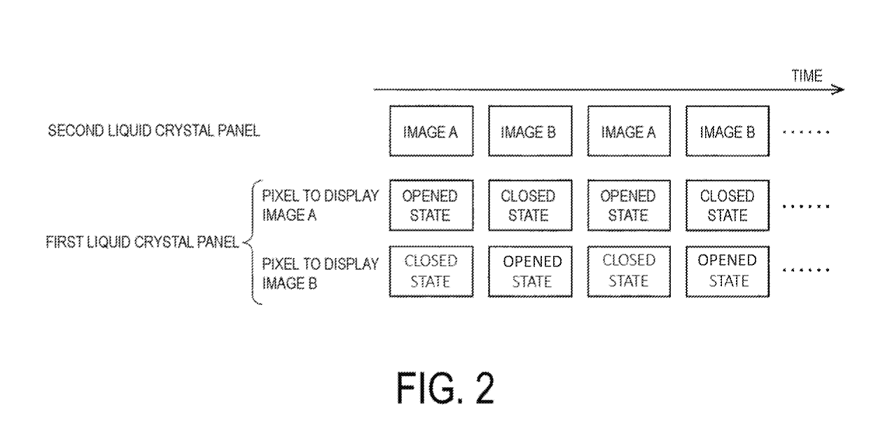

Based on the above-discussed point, the first method will be described below with reference to FIG. 2. In the first method, two kinds of images (here, one of them is referred to as an “image A”, and the other one is referred to as an “image B”) are alternately displayed in the second liquid crystal panel 12 by time-division at high speed like in the active shutter system. In the first liquid crystal panel 11, different actions are carried out between pixels to display the image A on the display front face and pixels to display the image B on the display front face. To be specific, the pixel to display the image A is set to an opened state (a state in which light is allowed to pass through) when the image A is displayed in the second liquid crystal panel 12, and is set to a closed state (a state in which light is blocked) when the image B is displayed in the second liquid crystal panel 12. On the other hand, the pixel to display the image 13 is set to the closed state when the image A is displayed in the second liquid crystal panel 12, and is set to the opened state when the image B is displayed in the second liquid crystal panel 12. As discussed above, in the first liquid crystal panel 11, an applied voltage is controlled for each pixel so that, when the image A is displayed in the second liquid crystal panel 12, the pixel to display the image A is in the opened state while the pixel to display the image B is in the closed state, and so that, when the image B is displayed in the second liquid crystal panel 12, the pixel to display the image A is in the closed state while the pixel to display the image B is in the opened state. In this manner, a combined image that looks as if the image A and the image B are superimposed is displayed on the display front face.

### 0.2.2 Second Method

In a 3D liquid crystal display device employing the passive system, an image for the left eye and an image for the right eye are alternately displayed spatially. For example, the image for the left eye is displayed on odd lines while the image for the right eye is displayed on even lines. A polarizing filter having different transmittance axes between the odd line and the even line is provided on the front face of the liquid crystal panel. For example, the transmittance axis of the odd line forms a positive angle of 45 degrees with respect to a certain reference axis, and the transmittance axis of the even line forms a negative angle of 45 degrees with respect to the stated reference axis. A viewer wears 3D glasses configured of a lens for the left eye including a polarizing filter having a transmittance axis corresponding to the odd line transmittance axis in the polarizing filter and a lens for the right eye including a polarizing filter having a transmittance axis corresponding to the even line transmittance axis in the polarizing filter. With this, the left eye sees only the image for the left eye and the right eye sees only the image for the right eye. As a result, a three-dimensional image is visually recognized by the viewer. Although the method using linear polarization has been described thus far, circular polarization can also be used.

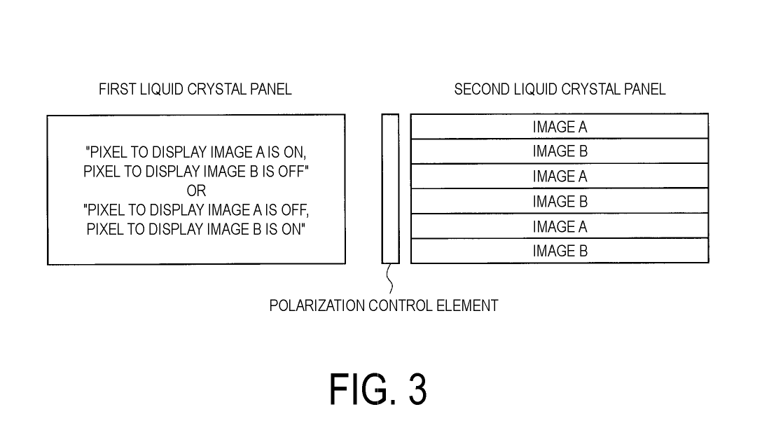

Based on the above-discussed point, the second method will be described below with reference to FIG. 3. In the second method, two kinds of images (also in this case, one of them is referred to as an “image A”, and the other one is referred to as an “image B”) are alternately displayed in the second liquid crystal panel 12 spatially like in the passive system. Typically, the image A and the image B are alternately displayed line by line. A polarization control element configured to set light of the image A and light of the image B in different polarization states is provided on the front face side of the second liquid crystal panel 12. With this, two types of light having mutually different polarization states are supplied to the first liquid crystal panel 11. As discussed earlier, the first liquid crystal panel emission-side polarizing plate 21 is provided on the front face side of the first liquid crystal panel 11. As for the first liquid crystal panel emission-side polarizing plate 21, the transmittance axis direction is determined so that the pixel to which the on-voltage is applied in the first liquid crystal panel 11 blocks the light of the image B and allows the light of the image A to pass through, and so that the pixel to which the off-voltage is applied in the first liquid crystal panel 11 blocks the light of the image A and allows the light of the image B to pass through. The transmittance axis direction of the first liquid crystal panel emission-side polarizing plate 21 may be determined so that the pixel to which the on-voltage is applied in the first liquid crystal panel 11 blocks the light of the image A and allows the light of the image B to pass through, and so that the pixel to which the off-voltage is applied in the first liquid crystal panel 11 blocks the light of the image B and allows the light of the image A to pass through. On the assumption as discussed above, in the first liquid crystal panel 11, the applied voltage is controlled for each pixel so that the pixel to display the image A is set to the on-voltage state and the pixel to display the image B is set to the off-voltage state, or so that the pixel to display the image A is set to the off-voltage state and the pixel to display the image B is set to the on-voltage state. By the applied voltage being controlled for each pixel as described above, a combined image that looks as if the image A and the image B are superimposed is displayed on the display front face.

### 1. First Embodiment

### 1.1 Structure

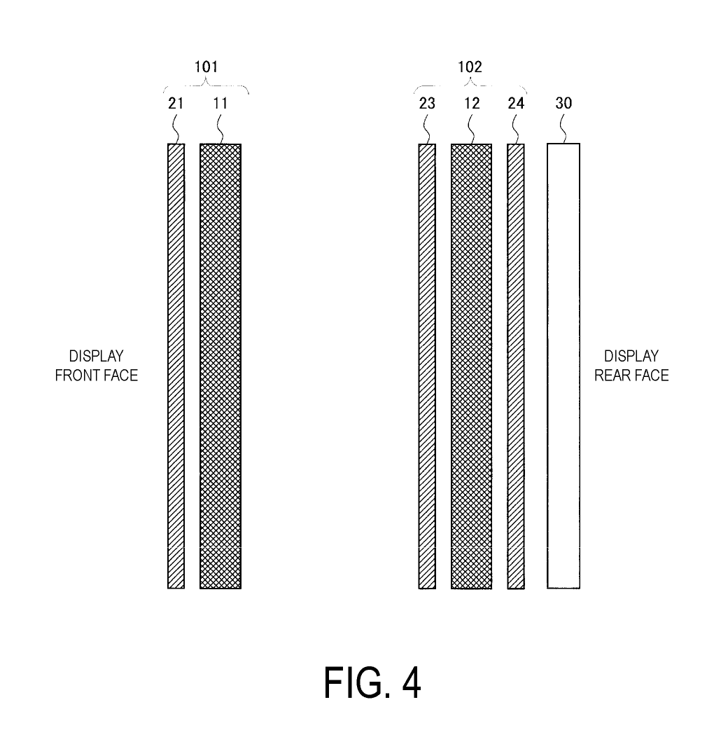

FIG. 4 is a diagram illustrating a structure of an image display device according to the first embodiment of the present invention. The stated image display device includes the first liquid crystal display unit 101, the second liquid crystal display unit 102, and the backlight light source 30. The first liquid crystal display unit 101 is constituted of the first liquid crystal panel 11 and the first liquid crystal panel emission-side polarizing plate 21 disposed on a front face side relative to the first liquid crystal panel 11. The second liquid crystal display unit 102 is constituted of the second liquid crystal panel 12, the second liquid crystal panel incidence-side polarizing plate 24 disposed on a rear thee side relative to the second liquid crystal panel 12, and the second liquid crystal panel emission-side polarizing plate 23 disposed on the front face side relative to the second liquid crystal panel 12. As discussed above, in the present embodiment, the first liquid crystal panel emission-side polarizing plate 21, the first liquid crystal panel 11, the second liquid crystal panel emission-side polarizing plate 23, the second liquid crystal panel 12, the second liquid crystal panel incidence-side polarizing plate 24, and the backlight light source 30 are provided in that order from the display front face side toward the display rear thee side.

In the second liquid crystal display unit 102, the polarizing plates are provided on both the front face side and the rear face side of the second liquid crystal panel 12. Accordingly, an existing general 3D liquid crystal display device can be used for the second liquid crystal display unit 102.

The emission polarization direction associated with the second liquid crystal display unit 102 (the transmittance axis direction of the second liquid crystal panel emission-side polarizing plate 23) and the incidence polarization direction associated with the first liquid crystal display unit 101 (a rubbing direction of an alignment film on the incidence side of the first liquid crystal panel 11) are parallel to each other. A relationship between the incidence polarization direction associated with the first liquid crystal display unit 101 and the transmittance axis direction of the first liquid crystal panel emission-side polarizing plate 21 depends on a liquid crystal action mode (a TN mode, STN mode, or the like), a control mode (a normally black mode or normally white mode), or the like related to the first liquid crystal panel 11. As for the first liquid crystal panel 11, in a case where the TN mode is employed as the action mode and the normally black mode is employed as the control mode, the incidence polarization direction associated with the first liquid crystal display unit 101 becomes parallel to the transmittance axis direction of the first liquid crystal panel emission-side polarizing plate 21.

### 1.2 Action

In the present embodiment, image display is carried out using the above-discussed first method (the method in which the active shutter system of 3D display technique is applied). In other words, two kinds of images (also in this case, one of them is referred to as an “image A”, and the other one is referred to as an “image B”) are alternately displayed in the second liquid crystal panel 12 by time-division at high speed. In the first liquid crystal panel 11, an applied voltage is controlled for each pixel, whereby the image to be displayed is selected from the two kinds of images on a pixel-by-pixel basis. To be specific, the applied voltage is controlled for each pixel so that the pixel to display the image A is set to the opened state when the image A is displayed in the second liquid crystal panel 12, and is set to the closed state when the image B is displayed in the second liquid crystal panel 12, and so that the pixel to display the image B is set to the closed state when the image A is displayed in the second liquid crystal panel 12, and is set to the opened state when the image B is displayed in the second liquid crystal panel 12. In this manner, shutter action is performed at high speed in each pixel of the first liquid crystal panel 11. As a result, a combined image (a combined image of the image A and the image B), as selection results across all the pixels, is displayed on the display front face.

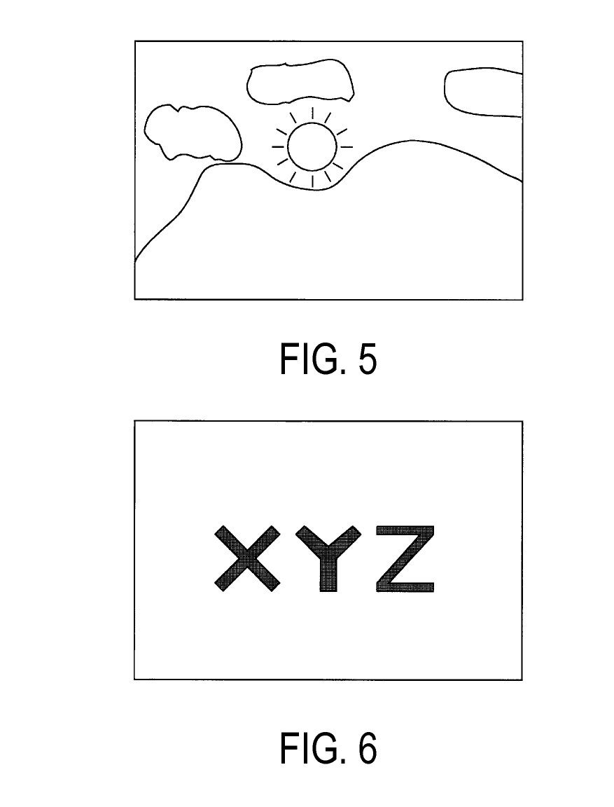

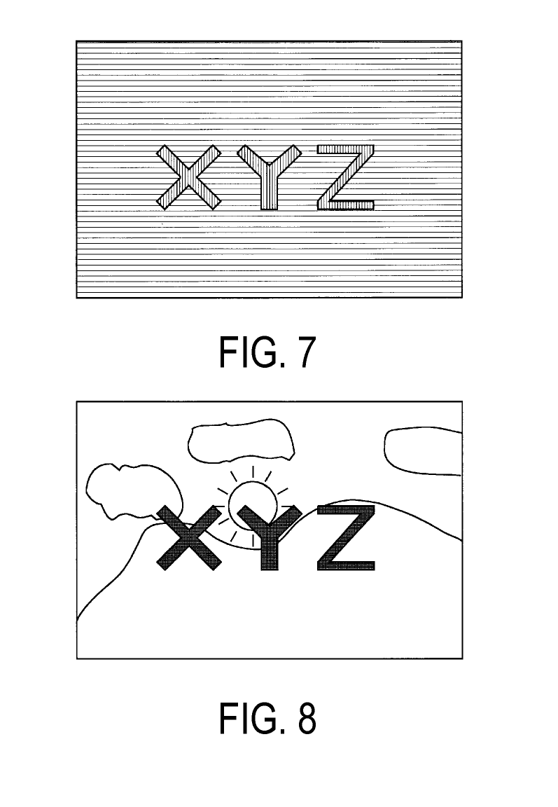

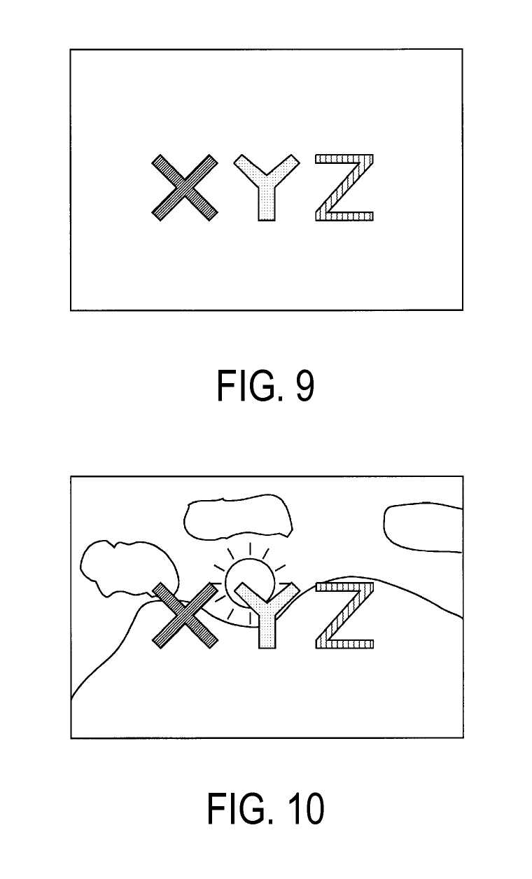

For example, it is assumed that the image A is an image illustrated in FIG. 5 and the image B is an image illustrated in FIG. 6. Further, it is assumed that a region indicated by horizontal lines in FIG. 7 is a region where the image A is to be displayed, and that a region indicated by vertical lines in FIG. 7 is a region where the image B is to be displayed. In this case, in the first liquid crystal panel 11, the image illustrated in FIG. 5 is selected at the pixels within the region indicated by the horizontal lines in FIG. 7, and the image illustrated in FIG. 6 is selected at the pixels within the region indicated by the vertical lines in FIG. 7. As a result, an image as illustrated in FIG. 8 is displayed on the display front face. In a case where the image B is an image as illustrated in FIG. 9, an image as illustrated in FIG. 10 is displayed on the display front face. However, this is ideal display and there exists a parallax in reality. As such, it is not always the case that a character image is clearly seen from the display front face side.

Note that in the present embodiment, two kinds of images need to be alternately displayed at high speed in the second liquid crystal panel 12, and the shutter action needs to be carried out at high speed in the first liquid crystal panel 11. As such, for the second liquid crystal panel 12 and the first liquid crystal panel 11, liquid crystal panels corresponding to the high speed drive need to be employed. However, since it is sufficient to carry out (in the regular use) switching between the opened state and the closed state in the first liquid crystal panel 11 (in other words, it is sufficient to control only two gray scales at each pixel), the first liquid crystal panel 11 is not required to operate at high speed in comparison with the second liquid crystal panel 12.

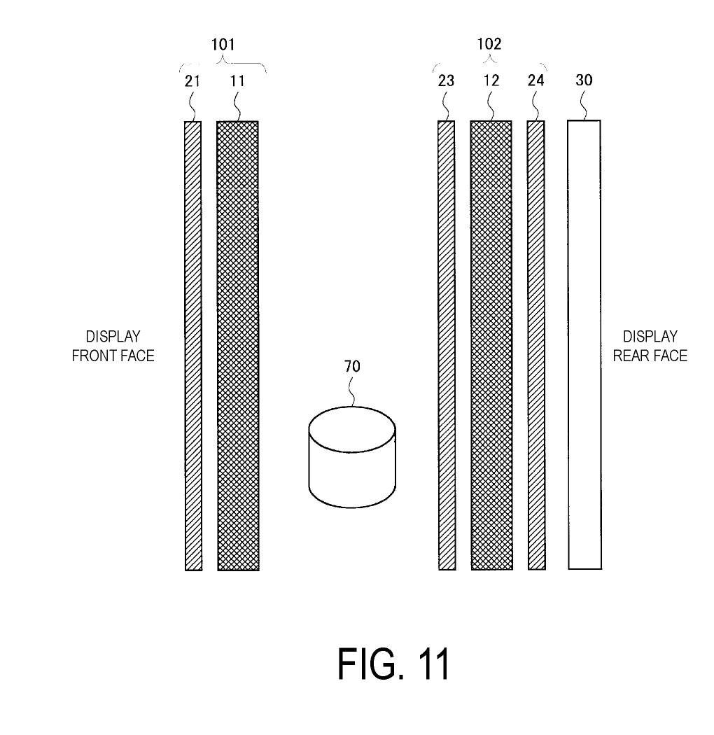

Note that in the present embodiment, a polarizing plate is not provided on the rear face side of the first liquid crystal panel 11. Because of this, for example, in a case where an object 70 is placed between the first liquid crystal display unit 101 and the second liquid crystal display unit 102 as illustrated in FIG. 11, the object 70 cannot be blocked by the first liquid crystal display unit 101 so that the object 70 is always in a state of being seen through from the display front face.

### 1.3 Effect

According to the present embodiment, two kinds of images are displayed in the second liquid crystal panel 12 provided on the rear face side, and an image to be displayed on the display front face is selected on a pixel-by-pixel basis in the first liquid crystal panel 11 provided on the front face side. A color filter-less liquid crystal panel can be employed as the first liquid crystal panel 11 because it is only required to carry out “switching between the opened state and the closed state” to select the image in the first liquid crystal panel 11. With this, the transmittance of the liquid crystal panel on the front face side (the first liquid crystal panel 11) can be increased. Therefore, in the double display using two liquid crystal panels, the rear side of the liquid crystal panel on the front face side can be made easy to be seen. The two kinds of images (the image A and image B) visually recognized by a viewer in the present embodiment are both images displayed in the second liquid crystal panel 12. That is, there is no difference between a distance from a position of the viewer to a display face of the image A and a distance from the position of the viewer to a display face of the image 13. However, it can be thought of that an image displayed in a small area (e.g. a character image) in the liquid crystal panel on the front face side (the first liquid crystal panel 11) can be visually recognized, by the viewer, as being displayed on the front face side relative to the peripheral image (see FIG. 8 and FIG. 10). By taking this point into consideration, the image display device according to the present embodiment can display an image with a depth sensation, a three-dimensional sensation, and the like. In a case where the field sequential system is employed, it is necessary that the drive is carried out at least at triple the regular drive speed taking 60 Hz as a drive frequency. In contrast, in the present embodiment, it is sufficient that the drive is carried out at twice the regular drive speed to switch the two kinds of images at each frame. Accordingly, the image display device according to the present embodiment is not required to perform high speed drive in comparison with the field sequential system. As discussed above, according to the present embodiment, a double display capable of displaying an image with a depth sensation, a three-dimensional sensation, and the like can be provided while securing sufficient transmittance of the panel on the front face side, without employing high speed drive such as the field sequential system.

Although, in general, polarizing plates are provided on both sides of a liquid crystal panel, a polarizing plate is not provided on the rear face side of the first liquid crystal panel 11 in the present embodiment. With respect to this, the function of a polarizing plate to be provided on the rear face side of the first liquid crystal panel 11 is achieved by the polarizing plate provided on the front face side of the second liquid crystal panel 12 (the second liquid crystal panel emission-side polarizing plate 23). By employing the structure in which a polarizing plate is not provided on the rear face side of the first liquid crystal panel 11 as discussed above, components of light absorbed or reflected by the polarizing plate are lessened so that the light utilization efficiency, transmittance, and the like are enhanced. Further, because the number of necessary polarizing plates becomes smaller than before, an effect of reduction in manufacturing cost is obtained.

### 2. Second Embodiment

### 2.1 Structure

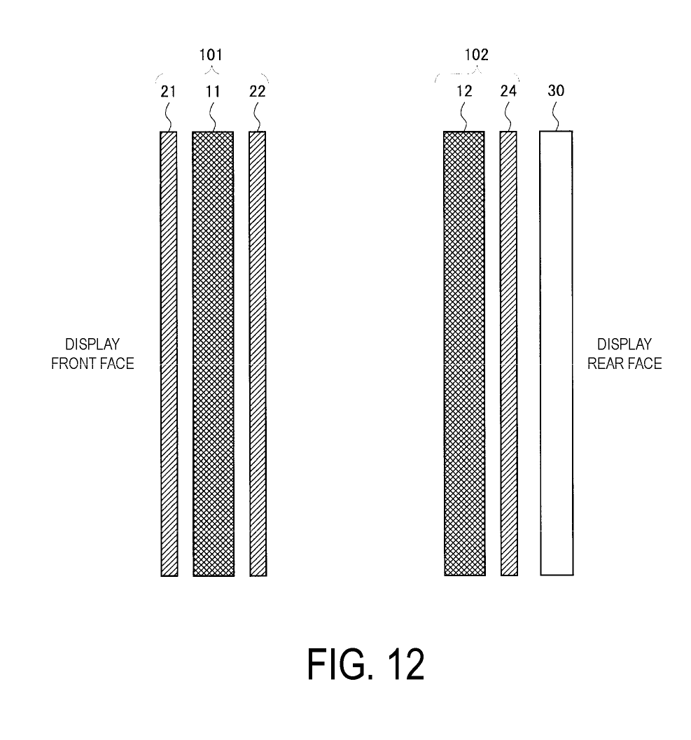

FIG. 12 is a diagram illustrating a structure of an image display device according to the second embodiment of the present invention. The stated image display device includes the first liquid crystal display unit 101, the second liquid crystal display unit 102, and the backlight light source 30. The first liquid crystal display unit 101 is constituted of the first liquid crystal panel 11, the first liquid crystal panel emission-side polarizing plate 21 disposed on a front face side relative to the first liquid crystal panel 11, and the first liquid crystal panel incidence-side polarizing plate 22 disposed on a rear face side relative to the first liquid crystal panel 11. The second liquid crystal display unit 102 is constituted of the second liquid crystal panel 12 and the second liquid crystal panel incidence-side polarizing plate 24 disposed on the rear face side relative to the second liquid crystal panel 12. As discussed above, in the present embodiment, the first liquid crystal panel emission-side polarizing plate 21, the first liquid crystal panel 11, the first liquid crystal panel incidence-side polarizing plate 22, the second liquid crystal panel 12, the second liquid crystal panel incidence-side polarizing plate 24, and the backlight light source 30 are provided in that order from the display front face side toward the display rear face side.

As can be understood from FIG. 4 and FIG. 12, a structure obtained in the following manner is a structure of the present embodiment: the second liquid crystal panel emission-side polarizing plate 23 is removed from the structure of the first embodiment; and then a polarizing plate (the first liquid crystal panel incidence-side polarizing plate 22) is added on the rear face side of the first liquid crystal panel 11. Note that in the present embodiment, an existing general 3D liquid crystal display device cannot be used for the second liquid crystal display unit 102.

### 2.2 Action

In the first embodiment, light emitted from the second liquid crystal panel 12 is linearly polarized by passing through the second liquid crystal panel emission-side polarizing plate 23 (see FIG. 4). However, in the present embodiment, the light emitted from the second liquid crystal panel 12 is linearly polarized by passing through the first liquid crystal panel incidence-side polarizing plate 22. Except for the above point, the same action as that of the first embodiment is performed in the present embodiment. That is, two kinds of images are alternately displayed by time-division at high speed in the second liquid crystal panel 12; in the first liquid crystal panel 11, an image to be displayed is selected from the two kinds of images on a pixel-by-pixel basis by the applied voltage being controlled for each pixel. With this, a combined image, as selection results across all the pixels, is displayed on the display front face.

### 2.3 Effect

Also in the present embodiment, like the first embodiment, a double display capable of displaying an image with a depth sensation, a three-dimensional sensation, and the like can be provided while securing sufficient transmittance of the panel on the front face side, without employing high speed drive such as the field sequential system. Further, the structure in which a polarizing plate is not provided on the front face side of the second liquid crystal panel 12, whereby an effect of improvement in light utilization efficiency, transmittance and the like, and an effect of reduction in manufacturing cost are obtained. Furthermore, according to the present embodiment, because a polarizing plate (the first liquid crystal panel incidence-side polarizing plate 22) is provided on the rear face side of the first liquid crystal panel 11, in the case where an object is placed between the first liquid crystal display unit 101 and the second liquid crystal display unit 102, the stated object can be blocked.

### 3. Third Embodiment

### 3.1 Structure

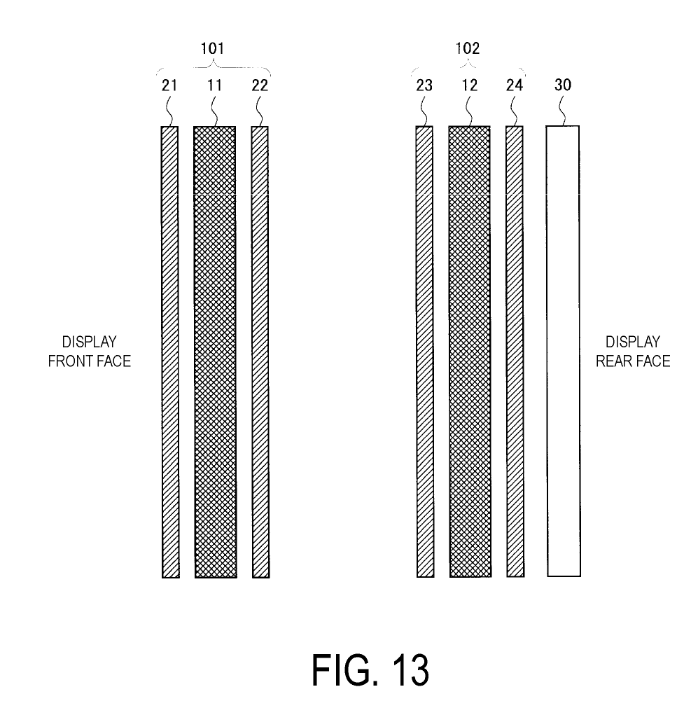

FIG. 13 is a diagram illustrating a structure of an image display device according to the third embodiment of the present invention. The stated image display device includes the first liquid crystal display unit 101, the second liquid crystal display unit 102, and the backlight light source 30. The first liquid crystal display unit 101 is constituted of the first liquid crystal panel 11, the first liquid crystal panel emission-side polarizing plate 21 disposed on a front face side relative to the first liquid crystal panel 11, and the first liquid crystal panel incidence-side polarizing plate 22 disposed on a rear face side relative to the first liquid crystal panel 11. The second liquid crystal display unit 102 is constituted of the second liquid crystal panel 12, the second liquid crystal panel incidence-side polarizing plate 24 disposed on a rear face side relative to the second liquid crystal panel 12, and the second liquid crystal panel emission-side polarizing plate 23 disposed on the front face side relative to the second liquid crystal panel 12. As discussed above, in the present embodiment, the first liquid crystal panel emission-side polarizing plate 21, the first liquid crystal panel 11, the first liquid crystal panel incidence-side polarizing plate 22, the second liquid crystal panel emission-side polarizing plate 23, the second liquid crystal panel 12, the second liquid crystal panel incidence-side polarizing plate 24, and the backlight light source 30 are provided in that order from the display front face side toward the display rear face side.

As can be understood from FIGS. 4, 12, and 13, in the present embodiment, the same structure as that of the second embodiment is employed for the first liquid crystal display unit 101, and the same structure as that of the first embodiment is employed for the second liquid crystal display unit 102. The transmittance axis of the second liquid crystal panel emission-side polarizing plate 23 and the transmittance axis of the first liquid crystal panel incidence-side polarizing plate 22 are parallel to each other.

### 3.2 Action

Also in the present embodiment, like the first embodiment, two kinds of images are alternately displayed by time-division at high speed in the second liquid crystal panel 12; in the first liquid crystal panel 11, the image to be displayed is selected from the two kinds of images on a pixel-by-pixel basis by the applied voltage being controlled for each pixel. With this, a combined image, as selection results across all the pixels, is displayed on the display front face.

### 3.3 Effect

Also in the present embodiment, like the first embodiment, a double display capable of displaying an image with a depth sensation, a three-dimensional sensation, and the like can be provided while securing sufficient transmittance of the panel on the front face side, without employing high speed drive such as the field sequential system. Further, according to the present embodiment, an effect of enhancement in contrast is obtained because, different from the first and second embodiments, the polarizing plates are provided on both the rear face side of the first liquid crystal panel 11 and the front face side of the second liquid crystal panel 12. Furthermore, according to the present embodiment, because a polarizing plate (the first liquid crystal panel incidence-side polarizing plate 22) is provided on the rear face side of the first liquid crystal panel 11, in the case where an object is placed between the first liquid crystal display unit 101 and the second liquid crystal display unit 102, the stated object can be blocked.

### 4. Fourth Embodiment

### 4.1 Structure

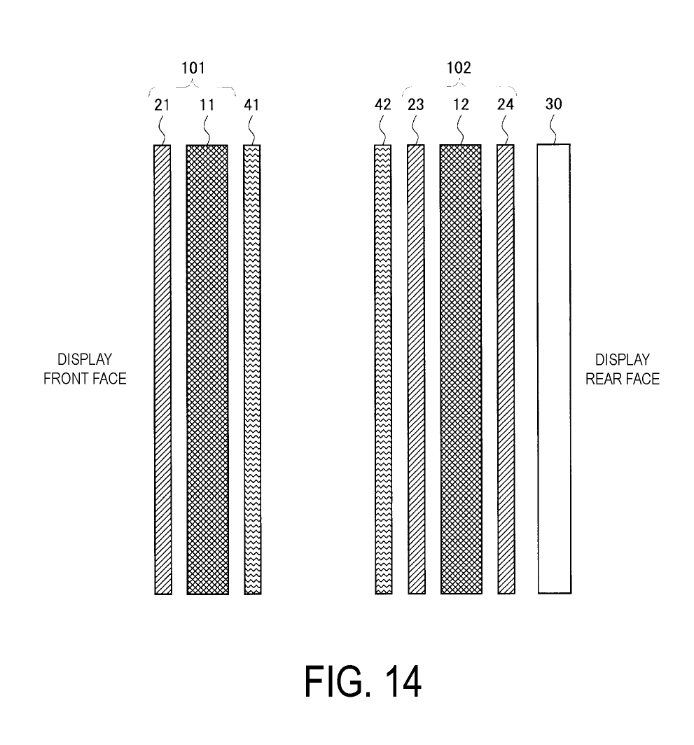

FIG. 14 is a diagram illustrating a structure of an image display device according to the fourth embodiment of the present invention. The structure of the image display device according to the present embodiment is such that two λ/4 wavelength plates (a first λ/4 wavelength plate 41 and a second λ/4 wavelength plate 42) are added to the structure of the image display device according to the first embodiment (see FIG. 4). The first λ/4 wavelength plate 41 is provided on a rear face side of the first liquid crystal display unit 101, and the second λ/4 wavelength plate 42 is provided on a front face side of the second liquid crystal display unit 102. As discussed above, in the present embodiment, the first liquid crystal panel emission-side polarizing plate 21, the first liquid crystal panel 11, the first λ/4 wavelength plate 41, the second λ/4 wavelength plate 42, the second liquid crystal panel emission-side polarizing plate 23, the second liquid crystal panel 12, the second liquid crystal panel incidence-side polarizing plate 24, and the backlight light source 30 are provided in that order from the display front face side toward the display rear face side.

### 4.2 Wavelength Plate

Here, the wavelength plate will be described. The wavelength plate is a plate configured to generate a predetermined phase difference between polarized components of light orthogonal to each other. Various types of wavelength plates are present, and in general, a λ/4 wavelength plate and a λ/2 wavelength plate are frequently used. In the present embodiment, two λ/4 wavelength plates are provided between the first liquid crystal display unit 101 and the second liquid crystal display unit 102. In the λ/4 wavelength plate, light travels being divided into two polarized components orthogonal to each other. The wavelength plate is manufactured using such a member that the refractive indices for the two polarized components differ from each other (e.g. organic material). Therefore, after the two polarized components having passed through the λ/4 wavelength plate, a phase difference is generated between the stated two polarized components. In the λ/4 wavelength plate, the phase difference between the two polarized components becomes λ/4 (90 degrees).

In the present embodiment, a manner of arrangement of the two λ/4 wavelength plates (the first λ/4 wavelength plate 41 and second λ/4 wavelength plate 42) differs depending on a relationship between the emission polarization direction associated with the second liquid crystal display unit 102 (the transmittance axis direction of the second liquid crystal panel emission-side polarizing plate 23) and the incidence polarization direction associated with the first liquid crystal display unit 101 (the alignment film rubbing direction on the incidence side of the first liquid crystal panel 11). This will be described below.

4.2.1 Case in which Emission Polarization Direction Matches Incidence Polarization Direction

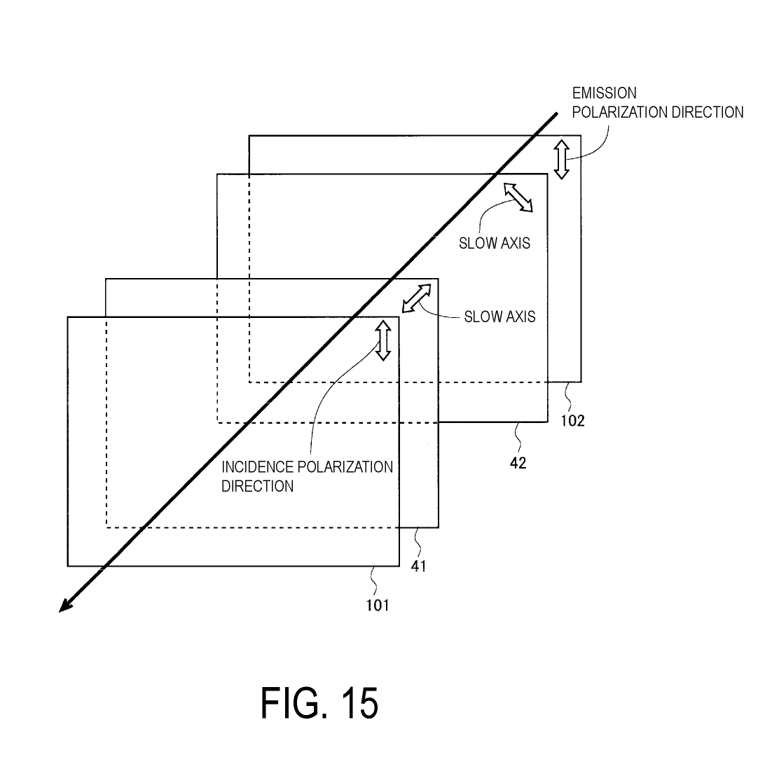

FIG. 15 is a diagram for describing how to dispose a λ/4 wavelength plate in a case in which an emission polarization direction associated with the second liquid crystal display unit 102 matches an incidence polarization direction associated with the first liquid crystal display unit 101. As can be understood from FIG. 15, a slow axis direction of one of the two λ/4 wavelength plates (e.g. the first λ/4 wavelength plate 41) corresponds to a direction in which the emission polarization direction and the incidence polarization direction are rotated by 45 degrees in a right handed manner, and a slow axis direction of the other one of the two λ/4 wavelength plates (e.g. the second λ/4 wavelength plate 42) corresponds to a direction in which the emission polarization direction and the incidence polarization direction are rotated by 45 degrees in a left handed manner. The two λ/4 wavelength plates (the first λ/4 wavelength plate 41 and second λ/4 wavelength plate 42) are disposed so that the slow axis directions take the directions as discussed above.

4.2.2 Case in which Emission Polarization Direction and Incidence Polarization Direction are Orthogonal

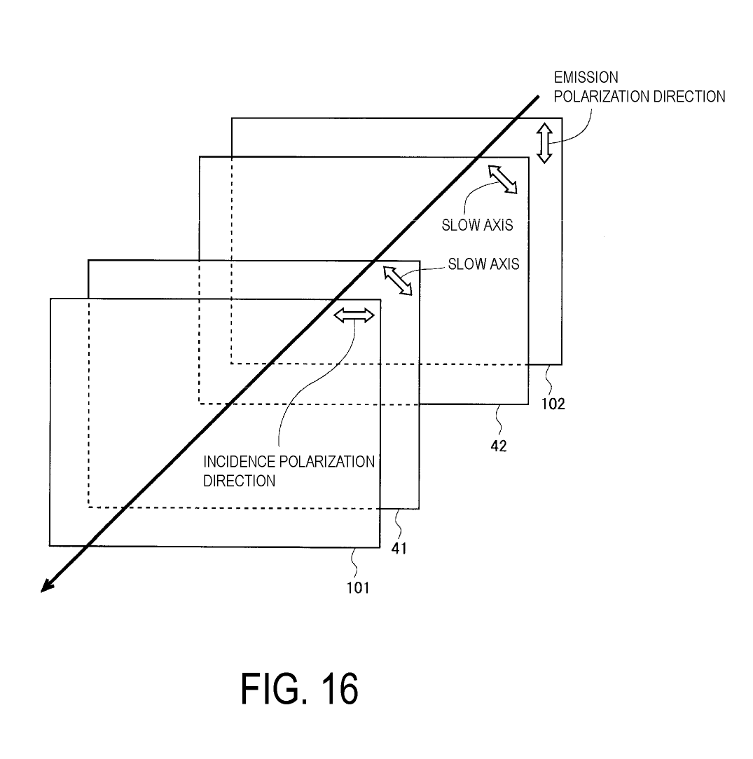

FIG. 16 is a diagram for describing how to dispose a λ/4 wavelength plate in a case in which an emission polarization direction associated with the second liquid crystal display unit 102 and an incidence polarization direction associated with the first liquid crystal display unit 101 are orthogonal to each other. As can be understood from FIG. 16, the slow axis directions of the two λ/4 wavelength plates (the first λ/4 wavelength plate 41 and second λ/4 wavelength plate 42) take the same direction. The stated slow axis directions form an angle of 45 degrees with respect to both the emission polarization direction and the incidence polarization direction. The two λ/4 wavelength plates (the first λ/4 wavelength plate 41 and second λ/4 wavelength plate 42) are disposed so that the slow axis directions take the directions as discussed above.

### 4.3 Effect

In a case where a transparent member is disposed between the first liquid crystal display unit 101 and the second liquid crystal display unit 102 due to a structural reason, there arises a possibility that surface reflection generated in a space between the first liquid crystal display unit 101 and the second liquid crystal display unit 102 may have influence upon display. With respect to this point, according to the present embodiment, two λ/4 wavelength plates (the first λ/4 wavelength plate 41 and second wavelength plate 42) are provided between the first liquid crystal display unit 101 and the second liquid crystal display unit 102. By arranging the first λ/4 wavelength plate 41 near the first liquid crystal display unit 101 and arranging the second λ/4 wavelength plate 42 near the second liquid crystal display unit 102, the influence of surface reflection generated in the space between the first liquid crystal display unit 101 and the second liquid crystal display unit 102 upon display can be reduced. As discussed above, according to the present embodiment, the influence of surface reflection of light upon display can be reduced.

In a case where an emission polarization direction associated with the second liquid crystal display unit 102 and an incidence polarization direction associated with the first liquid crystal display unit 101 are orthogonal to each other, the polarization direction of emission light from the second liquid crystal display unit 102 can be matched, after the emission light passes through two λ/4 wavelength plates, with the incidence polarization direction associated with the first liquid crystal display unit 101 by arranging the two λ/4 wavelength plates (the first λ/4 wavelength plate 41 and second λ/4 wavelength plate 42) as illustrated in FIG. 16.

In the case where an object is disposed between the first λ/4 wavelength plate 41 and the second λ/4 wavelength plate 42, there arises a possibility that the object 70 cannot be seen. With respect to this, like in the ninth embodiment to be explained later, by employing a structure in which a light source to radiate light toward a space between the first liquid crystal display unit 101 and the second liquid crystal display unit 102 (a space between the first λ/4 wavelength plate 41 and the second λ/4 wavelength plate 42) is provided, the emission light from the stated light source is not blocked so that the above object can be seen by the viewer.

### 4.4 Variation

In the above-discussed fourth embodiment, two λ/4 wavelength plates are provided between the first liquid crystal display unit 101 and the second liquid crystal display unit 102 while taking the structure of the first embodiment (see FIG. 4) as a reference. However, the present invention is not limited thereto. While taking the structure of the second embodiment (see FIG. 12) or the structure of the third embodiment (see FIG. 13) as a reference, a structure in which two λ/4 wavelength plates are provided between the first liquid crystal display unit 101 and the second liquid crystal display unit 102 can also be employed.

### 5. Fifth Embodiment

### 5.1 Structure

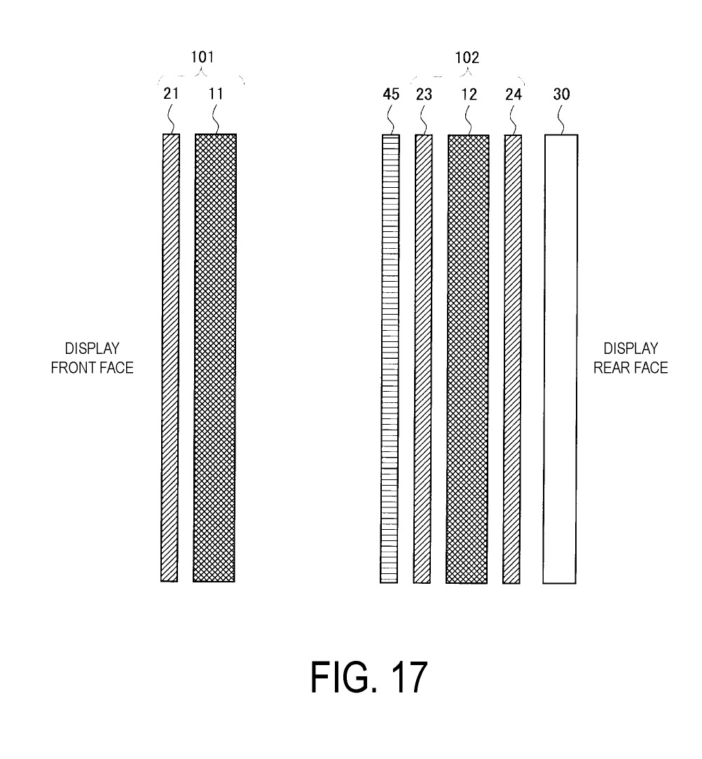

FIG. 17 is a diagram illustrating a structure of an image display device according to the fifth embodiment of the present invention. The structure of the image display device according to the present embodiment is such that a λ/2 wavelength plate 45 is added to the structure of the image display device according to the first embodiment (see FIG. 4). As discussed above, in the present embodiment, the first liquid crystal panel emission-side polarizing plate 21, the first liquid crystal panel 11, the λ/2 wavelength plate 45, the second liquid crystal panel emission-side polarizing plate 23, the second liquid crystal panel 12, the second liquid crystal panel incidence-side polarizing plate 24, and the backlight light source 30 are provided in that order from the display front face side toward the display rear face side.

### 5.2. λ/2 Wavelength Plate

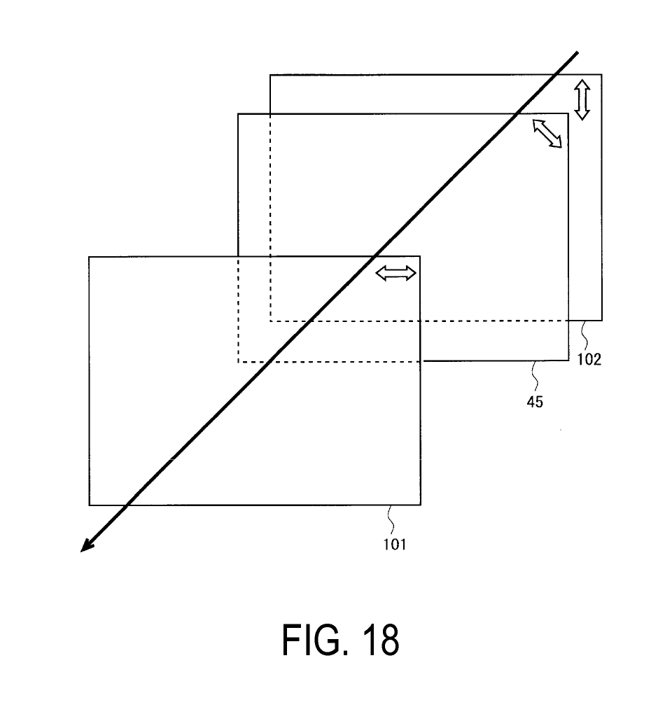

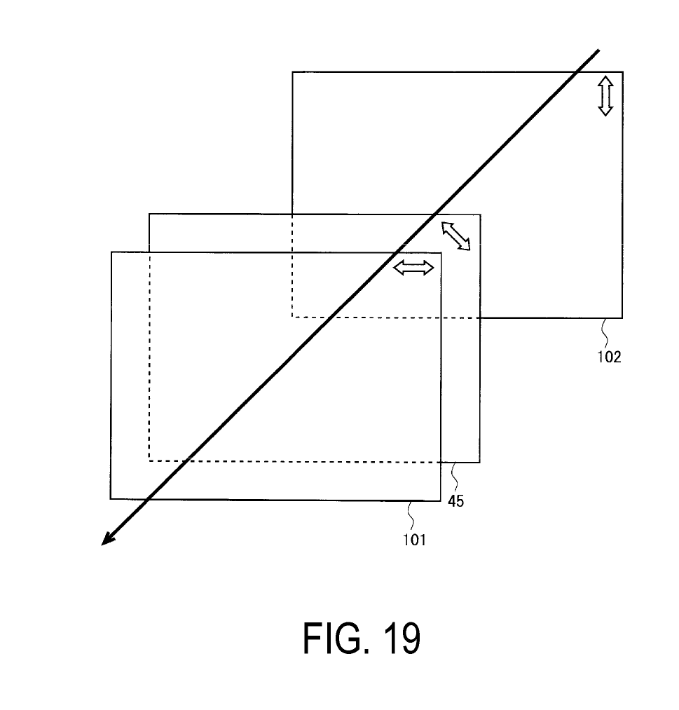

As described above, the wavelength plate is a plate configured to generate a predetermined phase difference between polarized components of light orthogonal to each other. Here, the λ/2 wavelength plate is a plate configured to generate a phase difference between two polarized components by λ/2 (180 degrees). FIG. 18 and FIG. 19 are diagrams for describing how to dispose the λ/2 wavelength plate 45. FIG. 18 is a diagram schematically illustrating a structure in which the λ/2 wavelength plate 45 is disposed on the second liquid crystal display unit 102 side, while FIG. 19 is a diagram schematically illustrating a structure in which the λ/2 wavelength plate 45 is disposed on the first liquid crystal display unit 101 side. The λ/2 wavelength plate 45 is provided between the second liquid crystal display unit 102 and the first liquid crystal display unit 101 so that a slow axis direction thereof matches an intermediate direction between the emission polarization direction associated with the second liquid crystal display unit 102 and the incidence polarization direction associated with the first liquid crystal display unit 101. As discussed above, in a case where a polarization direction of light emitted from the front face side of the second liquid crystal display unit 102 is defined as a first direction and a polarization direction of light incident on the first liquid crystal display unit 101 when a desired image is displayed in the first liquid crystal display unit 101 is defined as a second direction, an angle formed by the first direction and the slow axis direction of the λ/2 wavelength plate 45 and an angle formed by the second direction and the slow axis direction of the λ/2 wavelength plate 45 match.

### 5.3 Effect

According to the present embodiment, regardless of a relationship between the emission polarization direction associated with the second liquid crystal display unit 102 and the incidence polarization direction associated with the first liquid crystal display unit 101, in a case where the respective polarization directions (the emission polarization direction and incidence polarization direction) are known, the polarization direction of emission light from the second liquid crystal display unit 102 can be matched, after the emission light passing through the λ/2 wavelength plate 45, with the incidence polarization direction associated with the first liquid crystal display unit 101 by arranging the λ/2 wavelength plate 45 with appropriate orientation.

### 5.4 Variation

In the above-discussed fifth embodiment, the one λ/2 wavelength plate 45 is provided between the first liquid crystal display unit 101 and the second liquid crystal display unit 102 while taking the structure of the first embodiment (see FIG. 4) as a reference. However, the present invention is not limited thereto. While taking the structure of the second embodiment (see FIG. 12) or the structure of the third embodiment (see FIG. 13) as a reference, a structure in which the one λ/2 wavelength plate 45 is provided between the first liquid crystal display unit 101 and the second liquid crystal display unit 102 can also be employed.

### 6. Sixth Embodiment

### 6.1 Structure

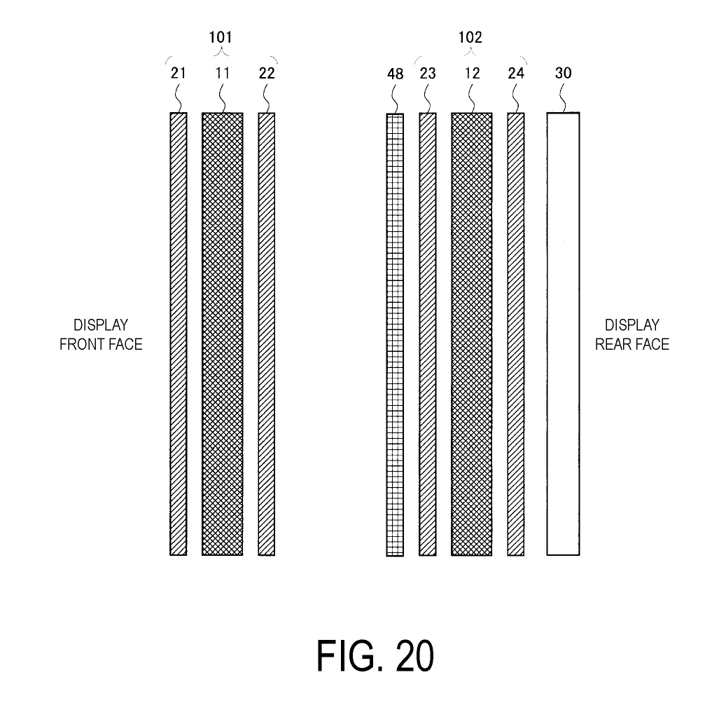

FIG. 20 is a diagram illustrating a structure of an image display device according to the sixth embodiment of the present invention. The structure of the image display device according to the present embodiment is such that a double refraction film 48 is added to the structure of the image display device according to the third embodiment (see FIG. 13). As discussed above, in the present embodiment, the first liquid crystal panel emission-side polarizing plate 21, the first liquid crystal panel 11, the first liquid crystal panel incidence-side polarizing plate 22, the double refraction film 48, the second liquid crystal panel emission-side polarizing plate 23, the second liquid crystal panel 12, the second liquid crystal panel incidence-side polarizing plate 24, and the backlight light source 30 are provided in that order from the display front face side toward the display rear face side.

### 6.2 Double Refraction Film

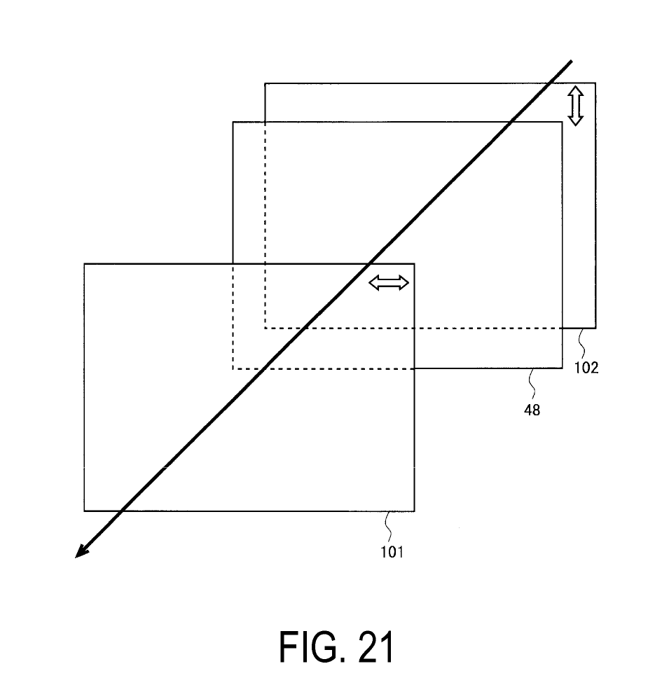

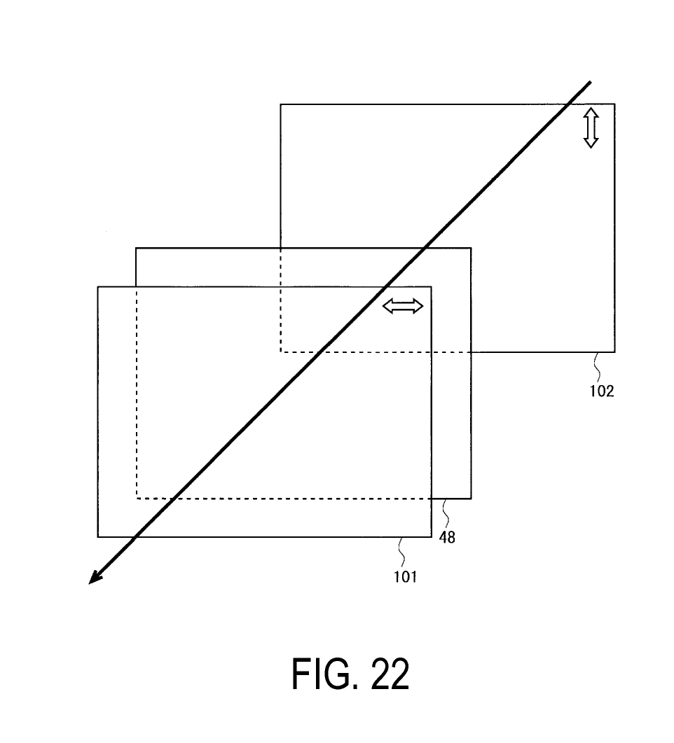

FIG. 21 and FIG. 22 are diagrams for describing how to dispose the double refraction film 48. FIG. 21 is a diagram schematically illustrating a structure in which the double refraction film 48 is disposed on the second liquid crystal display unit 102 side, while FIG. 22 is a diagram schematically illustrating a structure in which the double refraction film 48 is disposed on the first liquid crystal display unit 101 side. The double refraction film is a film configured to decompose linearly polarized light to make it in a state of not having a specific vibration direction like elliptic polarization (a random polarization state). Accordingly, in the case where the double refraction film 48 is disposed in a path of light having passed through the second liquid crystal display unit 102, the light having passed through the double refraction film 48 certainly contains components vibrating in the same direction as the incidence polarization direction associated with the first liquid crystal display unit 101. As such, in the present embodiment, the double refraction film 48 is provided between the second liquid crystal display unit 102 and the first liquid crystal display unit 101 without considering the relationship between the emission polarization direction associated with the second liquid crystal display unit 102 and the incidence polarization direction associated with the first liquid crystal display unit 101.

### 6.3 Effect

According to the present embodiment, the double refraction film 48 is provided between the second liquid crystal display unit 102 and the first liquid crystal display unit 101. Because of this, light supplied to the first liquid crystal display unit 101 from the second liquid crystal display unit 102 certainly contains components vibrating in the same direction as the incidence polarization direction associated with the first liquid crystal display unit 101. This makes it possible to see the display by the second liquid crystal display unit 102 from the front face side of the first liquid crystal display unit 101, regardless of the relationship between the emission polarization direction associated with the second liquid crystal display unit 102 and the incidence polarization direction associated with the first liquid crystal display unit 101. Further, even in a case where the relationship between the emission polarization direction associated with the second liquid crystal display unit 102 and the incidence polarization direction associated with the first liquid crystal display unit 101 is not determined at the design time, the display by the second liquid crystal display unit 102 can be seen from the front face side of the first liquid crystal display unit 101.

### 7. Seventh Embodiment

### 7.1 Structure

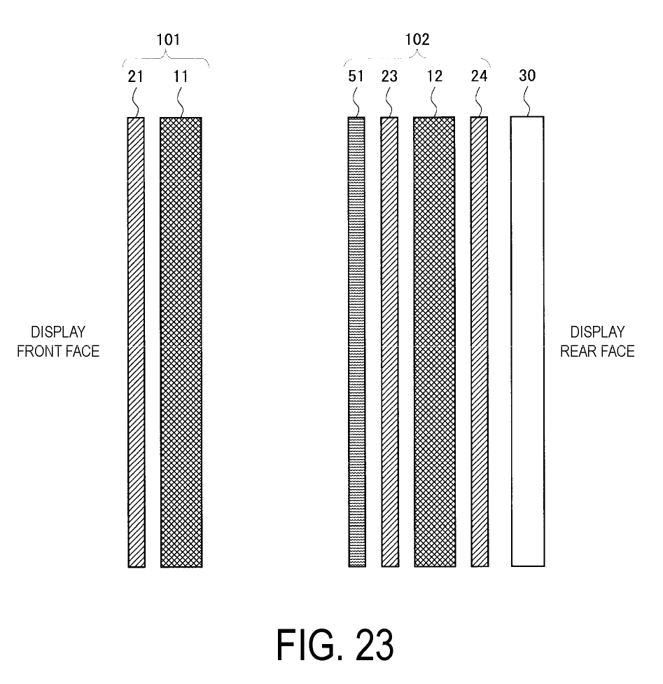

FIG. 23 is a diagram illustrating a structure of an image display device according to the seventh embodiment of the present invention. The stated image display device includes the first liquid crystal display unit 101, the second liquid crystal display unit 102, and the backlight light source 30. The first liquid crystal display unit 101 is constituted of the first liquid crystal panel 11 and the first liquid crystal panel emission-side polarizing plate 21 disposed on a front face side relative to the first liquid crystal panel 11. The second liquid crystal display unit 102 is constituted of the second liquid crystal panel 12, the second liquid crystal panel incidence-side polarizing plate 24 disposed on a rear face side relative to the second liquid crystal panel 12, the second liquid crystal panel emission-side polarizing plate 23 disposed on the front face side relative to the second liquid crystal panel 12, and a patterned polarizer (patterned polarizing plate) 51 as a polarization control element disposed on the front face side relative to the second liquid crystal panel emission-side polarizing plate 23. As discussed above, in the present embodiment, the first liquid crystal panel emission-side polarizing plate 21, the first liquid crystal panel 11, the patterned polarizer 51, the second liquid crystal panel emission-side polarizing plate 23, the second liquid crystal panel 12, the second liquid crystal panel incidence-side polarizing plate 24, and the backlight light source 30 are provided in that order from the display front face side toward the display rear face side.

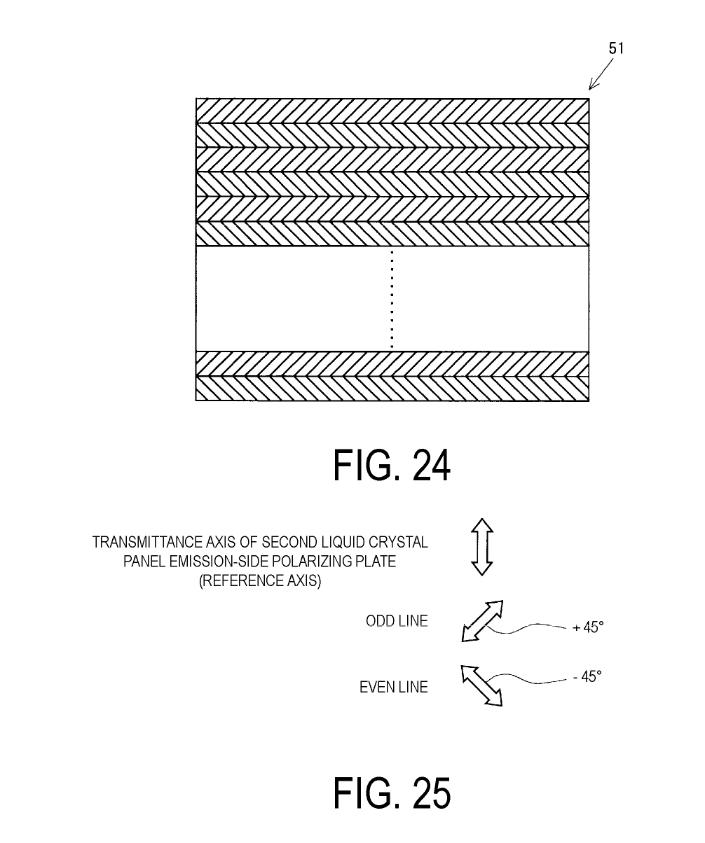

The patterned polarizer 51 has a structure in which two types of polarizing plates whose transmittance axes are orthogonal to each other are alternately disposed in striped form (line by line in general), as illustrated in FIG. 24. A specific example regarding the directions of transmittance axes of odd lines and even lines of the patterned polarizer 51, or the like will be described below. The specific example described below is merely an example, and the present invention is not limited thereto. Here, it is assumed that a liquid crystal panel whose action mode is a TN mode is employed as the first liquid crystal panel 11.

As for the patterned polarizer 51 of the present embodiment, in a case where the transmittance axis of the second liquid crystal panel emission-side polarizing plate 23 (hereinafter, referred to as a “reference axis” for convenience) is taken as a reference, the transmittance axis of the odd line forms a positive angle of 45 degrees with respect to the reference axis and the transmittance axis of the even line forms a negative angle of 45 degrees with respect to the reference axis, as illustrated in FIG. 25. The incidence polarization direction associated with the first liquid crystal display unit 101 (the alignment film rubbing direction on the incidence side of the first liquid crystal panel 11) and the transmittance axis direction of the odd line of the patterned polarizer 51 are parallel to each other. The transmittance axis of the first liquid crystal panel emission-side polarizing plate 21 forms a negative angle of 45 degrees with respect to the reference axis. In other words, the transmittance axis of the first liquid crystal panel emission-side polarizing plate 21 and the transmittance axis of the even line of the patterned polarizer 51 are parallel to each other.

### 7.2 Action

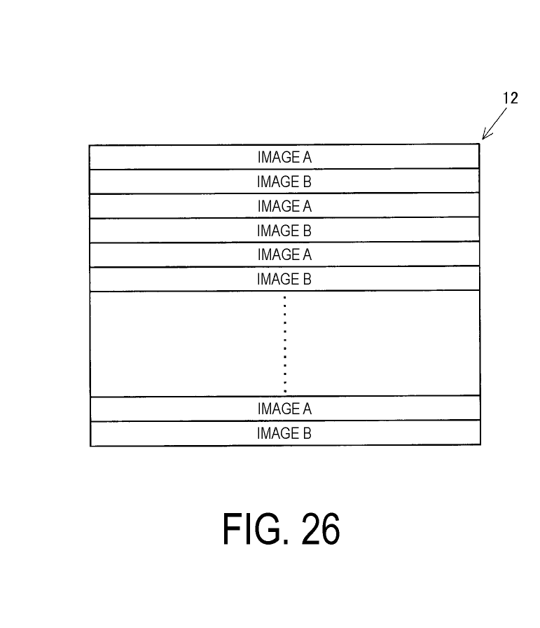

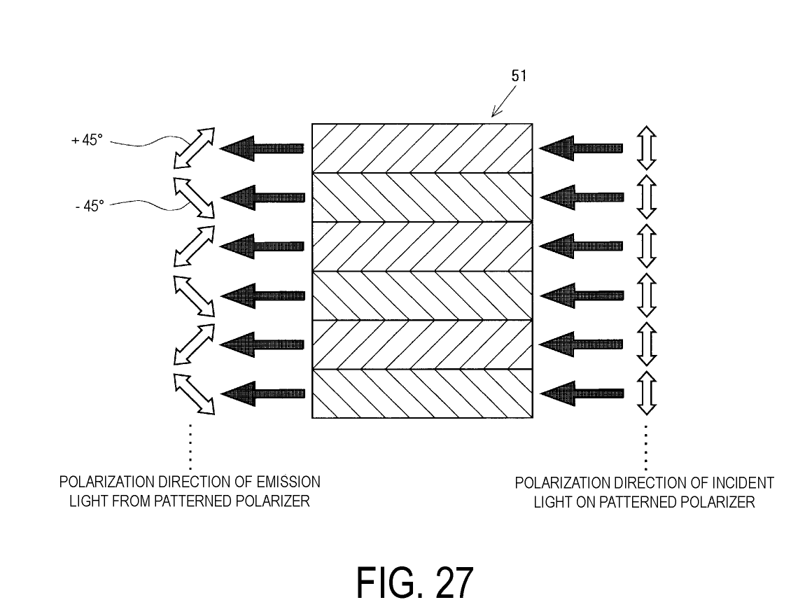

In the present embodiment, image display is carried out using the above-discussed second method (the method in which the passive system of 3D display technique is applied). In other words, two kinds of images (also in this case, one of them is referred to as an “image A”, and the other one is referred to as an “image B”) are alternately displayed in the second liquid crystal panel 12 spatially. To be more specific, as illustrated in FIG. 26, the image A is displayed on the odd lines and the image B is displayed on the even lines in the second liquid crystal panel 12. Light of the image A emitted from the patterned polarizer 51 becomes linearly polarized light having a polarization face that forms a positive angle of 45 degrees with respect to the reference axis, and light of the image B emitted from the patterned polarizer 51 becomes linearly polarized light having a polarization face that forms a negative angle of 45 degrees with respect to the reference axis (see FIG. 27).

As discussed above, the transmittance axis of the first liquid crystal panel emission-side polarizing plate 21 forms a negative angle of 45 degrees with respect to the reference axis. Accordingly, the polarization face of the light of the image A (linearly polarized light) incident on the first liquid crystal display unit 101 and the transmittance axis of the first liquid crystal panel emission-side polarizing plate 21 are orthogonal to each other, while the polarization face of the light of the image B (linearly polarized light) incident on the first liquid crystal display unit 101 and the transmittance axis of the first liquid crystal panel emission-side polarizing plate 21 are parallel to each other. As discussed above, the incidence polarization direction associated with the first liquid crystal display unit 101 and the transmittance axis direction of the odd line of the patterned polarizer 51 are parallel to each other. The action mode of the first liquid crystal panel 11 is a TN mode. Then, in the first liquid crystal panel 11, switching between “not rotate the polarization direction (polarization face) of the incident light” or “rotate the polarization direction (polarization face) of the incident light by 90 degrees” is carried out by voltage-on/off control. As described above, at the pixel to which the voltage is not applied in the first liquid crystal panel 11, the polarization direction of the incident light is rotated by 90 degrees, and as a result the light of the image A is allowed to pass through. On the other hand, at the pixel to which the voltage (a predetermined magnitude of voltage) is applied in the first liquid crystal panel 11, the polarization direction of the incident light is not rotated, and as a result the light of the image B is allowed to pass through. In this manner, by the applied voltage being controlled for each pixel in the first liquid crystal panel 11, the image to be displayed is selected from the two kinds of images on a pixel-by-pixel basis. As a result, a combined image (a combined image of the image A and the image B), as selection results across all the pixels, is displayed on the display front face.

As discussed above, in the present embodiment, the image A is displayed on the odd lines of the second liquid crystal panel 12 and the image B is displayed on the even lines of the second liquid crystal panel 12. Then, the patterned polarizer 51 makes the polarization state of the light of the image A be the first polarization state (the state of linear polarization having a polarization face that forms a positive angle of 45 degrees with respect to the reference axis) and makes the polarization state of the light of the image B be the second polarization state (the state of linear polarization having a polarization face that forms a negative angle of 45 degrees with respect to the reference axis). In the first liquid crystal panel 11, the applied voltage for each pixel is controlled so that the light of the second polarization state is blocked and the light of the first polarization state is allowed to pass through at the pixel to display the image A, and so that the light of the first polarization state is blocked and the light of the second polarization state is allowed to pass through at the pixel to display the image B.

### 7.3 Effect

According to the present embodiment, two kinds of images are displayed in the second liquid crystal panel 12 provided on the rear face side, and an image to be displayed is selected on a pixel-by-pixel basis in the first liquid crystal panel 11 provided on the front face side. A color filter-less liquid crystal panel can be employed as the first liquid crystal panel 11 because it is only required to carry out “switching between the voltage being on and the voltage being off” to select the image in the first liquid crystal panel 11. With this, the transmittance of the liquid crystal panel on the front face side (the first liquid crystal panel 11) can be increased. Therefore, in the double display using two liquid crystal panels, the rear side of the liquid crystal panel on the front face side can be made easy to be seen. Although both the two kinds of images visually recognized by a viewer in the present embodiment are images that are displayed in the second liquid crystal panel 12, it can be thought of that an image displayed in a small area (e.g. a character image) in the liquid crystal panel on the front face side (the first liquid crystal panel 11) can be visually recognized, by the viewer, as being displayed on a front face side relative to the peripheral image, like in the first embodiment. Accordingly, the image display device according to the present embodiment can display an image with a depth sensation, a three-dimensional sensation, and the like. In the present embodiment, since the structure in which two kinds of images are alternately displayed spatially is employed, the regular drive taking 60 Hz as a drive frequency can be employed. Because of this, generation of crosstalk (a phenomenon in which two kinds of images are mixed) can be suppressed. As discussed above, according to the present embodiment, a double display capable of suppressing the generation of crosstalk and displaying an image with a depth sensation, a three-dimensional sensation, and the like can be provided while securing sufficient transmittance of the panel on the front face side, without employing high speed drive such as the field sequential system or the like.

Further, like in the first embodiment, since the structure in which a polarizing plate is not provided on the rear face side of the first liquid crystal panel 11 is employed, an effect of improvement in light utilization efficiency, transmittance and the like, an effect of reduction in manufacturing cost, and the like are obtained.

In the structure in which the second method (the method in which the passive system of 3D display technique is applied) is employed like in the present embodiment, the degree of crosstalk generation depends on the degree of polarization of the two kinds of images.

### 8. Eighth Embodiment

### 8.1 Structure

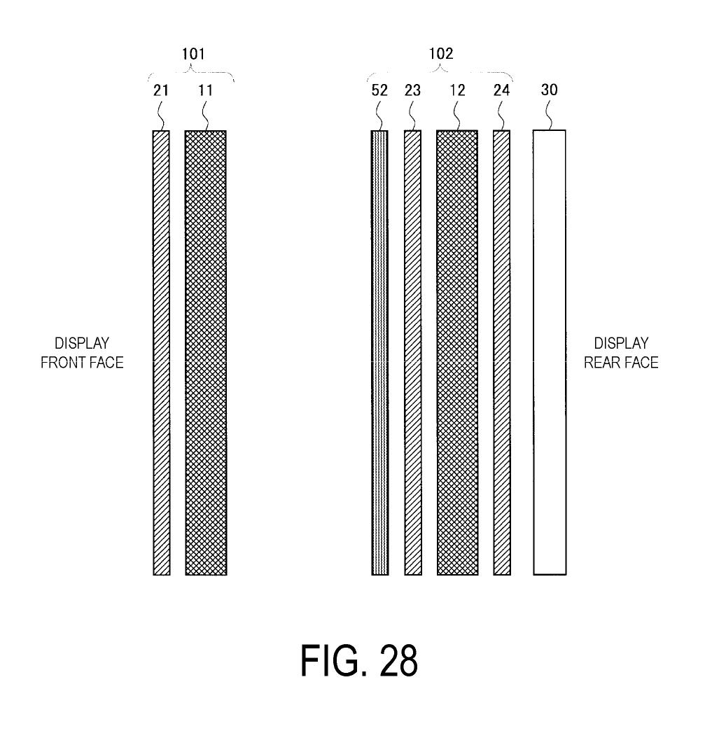

FIG. 28 is a diagram illustrating a structure of an image display device according to the eighth embodiment of the present invention. The stated image display device includes the first liquid crystal display unit 101, the second liquid crystal display unit 102, and the backlight light source 30. The first liquid crystal display unit 101 is constituted of the first liquid crystal panel 11 and the first liquid crystal panel emission-side polarizing plate 21 disposed on a front face side relative to the first liquid crystal panel 11. The second liquid crystal display unit 102 is constituted of the second liquid crystal panel 12, the second liquid crystal panel incidence-side polarizing plate 24 disposed on a rear face side relative to the second liquid crystal panel 12, the second liquid crystal panel emission-side polarizing plate 23 disposed on the front face side relative to the second liquid crystal panel 12, and a patterned retarder (patterned wavelength plate) 52 as a polarization control element disposed on the front face side relative to the second liquid crystal panel emission-side polarizing plate 23. As discussed above, in the present embodiment, the first liquid crystal panel emission-side polarizing plate 21, the first liquid crystal panel 11, the patterned retarder 52, the second liquid crystal panel emission-side polarizing plate 23, the second liquid crystal panel 12, the second liquid crystal panel incidence-side polarizing plate 24, and the backlight light source 30 are provided in that order from the display front face side toward the display rear face side.

In the present embodiment, the patterned retarder 52 is used as a polarization control element. The patterned retarder 52 has a structure in which two types of λ/2 wavelength plates with slow axes in mutually different directions are alternately disposed line by line (in striped form) so that two types of light with polarization directions orthogonal to each other are alternately emitted line by line (in striped form). As for the patterned retarder 52 in the present embodiment, it is assumed that the slow axis associated with the odd line is parallel to the transmittance axis (reference axis) of the second liquid crystal panel emission-side polarizing plate 23, and that the slow axis associated with the even line forms a positive angle of 45 degrees with respect to the reference axis. With this, the polarization direction of the emission light from the odd line of the patterned retarder 52 becomes parallel to the polarization direction of the incident light (linearly polarized light having passed through the second liquid crystal panel emission-side polarizing plate 23), and the polarization direction of the emission light from the even line of the patterned retarder 52 is orthogonal to the polarization direction of the incident light. However, for example, the patterned retarder 52 may be constituted such that, as for the odd line, the polarization direction of the emission light forms a positive angle of 22.5 degrees with respect to the polarization direction of the incident light, and as for the even line, the polarization direction of the emission light forms a negative angle of 22.5 degrees with respect to the polarization direction of the incident light. In other words, it is sufficient for the patterned retarder 52 to be constituted such that the polarization direction of the emission light associated with the odd line and the polarization direction of the emission light associated with the even line are orthogonal to each other.

### 8.2 Action

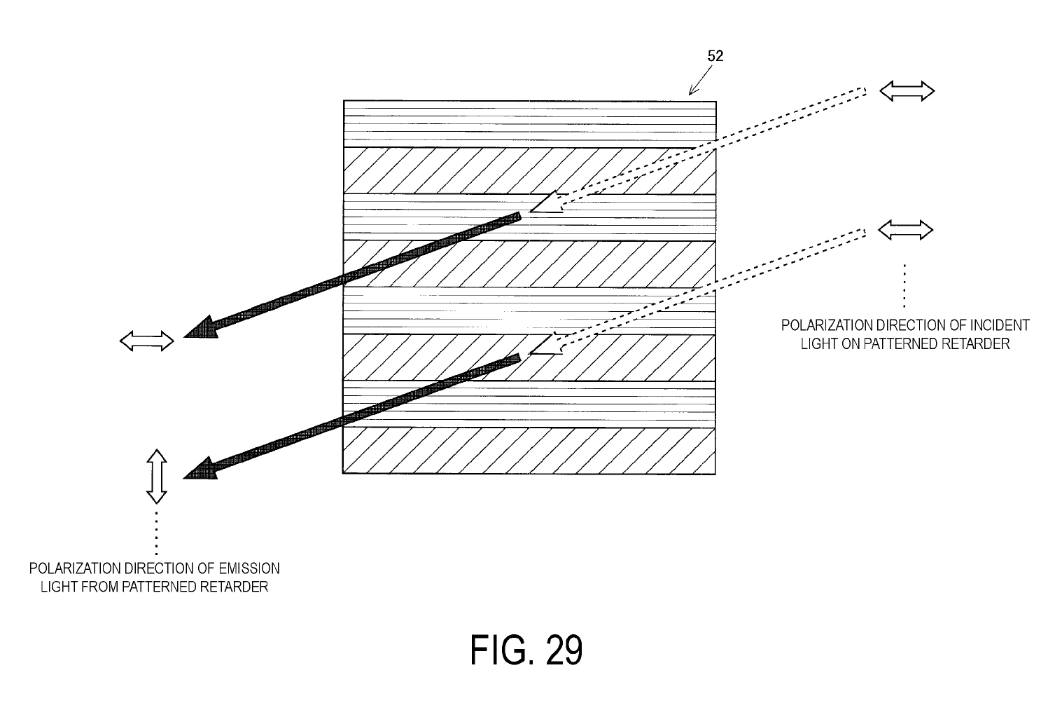

With reference to FIG. 29, how light travels through the patterned retarder 52 will be described below. In the present embodiment, linearly polarized light having a polarization face parallel to the transmittance axis of the second liquid crystal panel emission-side polarizing plate 23 is incident on the patterned retarder 52. The slow axis direction associated with the odd line of the patterned retarder 52 is parallel to the polarization direction of the incident light on the patterned retarder 52. Accordingly, as illustrated in FIG. 29, the polarization direction of the emission light from the odd line of the patterned retarder 52 (assumed to be “light of the image A” here) is parallel to the polarization direction of the incident light on the patterned retarder 52 (first polarization state). The slow axis direction associated with the even line of the patterned retarder 52 and the polarization direction of the incident light on the patterned retarder 52 form an angle of 45 degrees. Accordingly, as illustrated in FIG. 29, the polarization direction of the emission light from the even line of the patterned retarder 52 (assumed to be “light of the image B” here) is orthogonal to the polarization direction of the incident light on the patterned retarder 52 (second polarization state). In this manner, two types of linearly polarized light including polarization faces orthogonal to each other (linearly polarized light corresponding to the image A and linearly polarized light corresponding to the image B) are supplied to the first liquid crystal panel 11 inside the first liquid crystal display unit 101.

It is assumed here that the transmittance axis direction of the second liquid crystal panel emission-side polarizing plate 23 and the alignment film rubbing direction on the incidence side of the first liquid crystal panel 11 are parallel to each other, and that the transmittance axis of the second liquid crystal panel emission-side polarizing plate 23 and the transmittance axis of the first liquid crystal panel emission-side polarizing plate 21 are orthogonal to each other. In this case, the polarization face of the light of the image A (linearly polarized light) incident on the first liquid crystal display unit 101 and the transmittance axis of the first liquid crystal panel emission-side polarizing plate 21 are orthogonal to each other, and the polarization face of the light of the image 13 (linearly polarized light) incident on the first liquid crystal display unit 101 and the transmittance axis of the first liquid crystal panel emission-side polarizing plate 21 are parallel to each other. Also in the present embodiment, it is assumed that a liquid crystal panel whose action mode is a TN mode is employed as the first liquid crystal panel 11. Like in the seventh embodiment, switching between “not rotate the polarization direction (polarization face) of the incident light” or “rotate the polarization direction (polarization face) of the incident light by 90 degrees” is carried out by the voltage-on/off control in the first liquid crystal panel 11. With this, the same action as that of the seventh embodiment is performed in the first liquid crystal panel 11. As a result, at the pixel to which the voltage is not applied in the first liquid crystal panel 11, light of the image A is allowed to pass through; at the pixel to which the voltage (a predetermined magnitude of voltage) is applied in the first liquid crystal panel 11, light of the image B is allowed to pass through.

In the manner discussed above, like in the seventh embodiment, two kinds of images are alternately displayed spatially in the second liquid crystal panel 12 (mutually different kinds of images are displayed on the odd lines and the even lines respectively); in the first liquid crystal panel 11, the image to be displayed is selected from the two kinds of images on a pixel-by-pixel basis by the applied voltage being controlled for each pixel. With this, a combined image, as selection results across all the pixels, is displayed on the display front face.

### 8.3 Effect

Also in the present embodiment, like the seventh embodiment, a double display capable of suppressing the generation of crosstalk and displaying an image with a depth sensation, a three-dimensional sensation, and the like can be provided while securing sufficient transmittance of the panel on the front face side, without employing high speed drive such as the field sequential system or the like. Further, the structure in which a polarizing plate is not provided on the rear face side of the first liquid crystal panel 11 is employed, whereby an effect of improvement in light utilization efficiency, transmittance and the like, an effect of reduction in manufacturing cost, and the like are obtained.

In the seventh embodiment, the patterned polarizer 51 was used as a polarization control element. In this case, half the emission light from the second liquid crystal panel 12 is absorbed and not utilized. In other words, loss of the light occurs. As for this point, in the present embodiment, since the patterned retarder 52, as a polarization control element, having a structure in which λ/2 wavelength plates are alternately disposed in striped form is used, light utilization efficiency of the emission light from the second liquid crystal panel 12 is enhanced.

### 8.4 Variation

Although the patterned retarder 52 is used as a polarization control element in the eighth embodiment, an azimuth rotator (optical rotation film) configured to rotate polarized light on the same principle as that of the TN liquid crystal may be used instead of the patterned retarder 52 in order that the same action is performed.

### 9. Ninth Embodiment

### 9.1 Structure

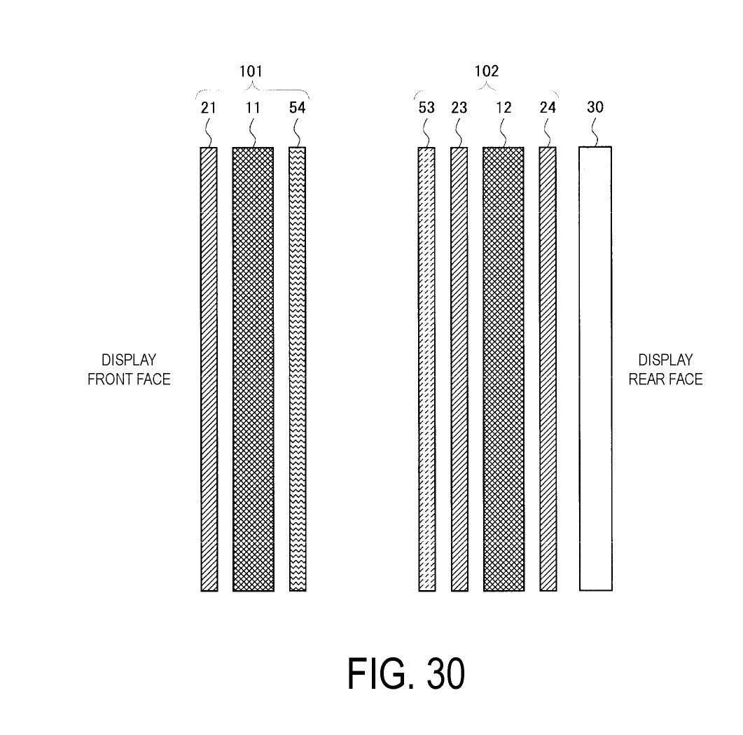

FIG. 30 is a diagram illustrating a structure of an image display device according to the ninth embodiment of the present invention. The stated image display device includes the first liquid crystal display unit 101, the second liquid crystal display unit 102, and the backlight light source 30. The first liquid crystal display unit 101 is constituted of the first liquid crystal panel 11, the first liquid crystal panel emission-side polarizing plate 21 disposed on a front face side relative to the first liquid crystal panel 11, and a λ/4 wavelength plate 54 disposed on a rear face side relative to the first liquid crystal panel 11. The second liquid crystal display unit 102 is constituted of the second liquid crystal panel 12, the second liquid crystal panel incidence-side polarizing plate 24 disposed on the rear face side relative to the second liquid crystal panel 12, the second liquid crystal panel emission-side polarizing plate 23 disposed on the front face side relative to the second liquid crystal panel 12, and a patterned retarder (patterned wavelength plate) 53 as a polarization control element disposed on the front face side relative to the second liquid crystal panel emission-side polarizing plate 23. As discussed above, in the present embodiment, the first liquid crystal panel emission-side polarizing plate 21, the first liquid crystal panel 11, the λ/4 wavelength plate 54, the patterned retarder 53, the second liquid crystal panel emission-side polarizing plate 23, the second liquid crystal panel 12, the second liquid crystal panel incidence-side polarizing plate 24, and the backlight light source 30 are provided in that order from the display front face side toward the display rear face side.

In the present embodiment, the patterned retarder 53 is used as a polarization control element. The patterned retarder 53 has a structure in which two types of λ/4 wavelength plates with slow axes in mutually different directions are alternately disposed line by line (in striped form) so that the right handed circularly-polarized light and the left handed circularly-polarized light are alternately emitted line by line (in striped form). Specifically, the patterned retarder 53 is constituted such that the slow axis associated with one of the odd line and the even line forms a positive angle of 45 degrees with respect to the transmittance axis (reference axis) of the second liquid crystal panel emission-side polarizing plate 23, and the slow axis associated with the other one of the odd line and the even line forms a negative angle of 45 degrees with respect to the reference axis. The slow axis direction of the λ/4 wavelength plate 54 is parallel to the slow axis direction associated with the one of the odd line and the even line of the patterned retarder 53. The λ/4 wavelength plate 54 is a general λ/4 wavelength plate having a slow axis in the same direction across the whole face.

### 9.2 Action

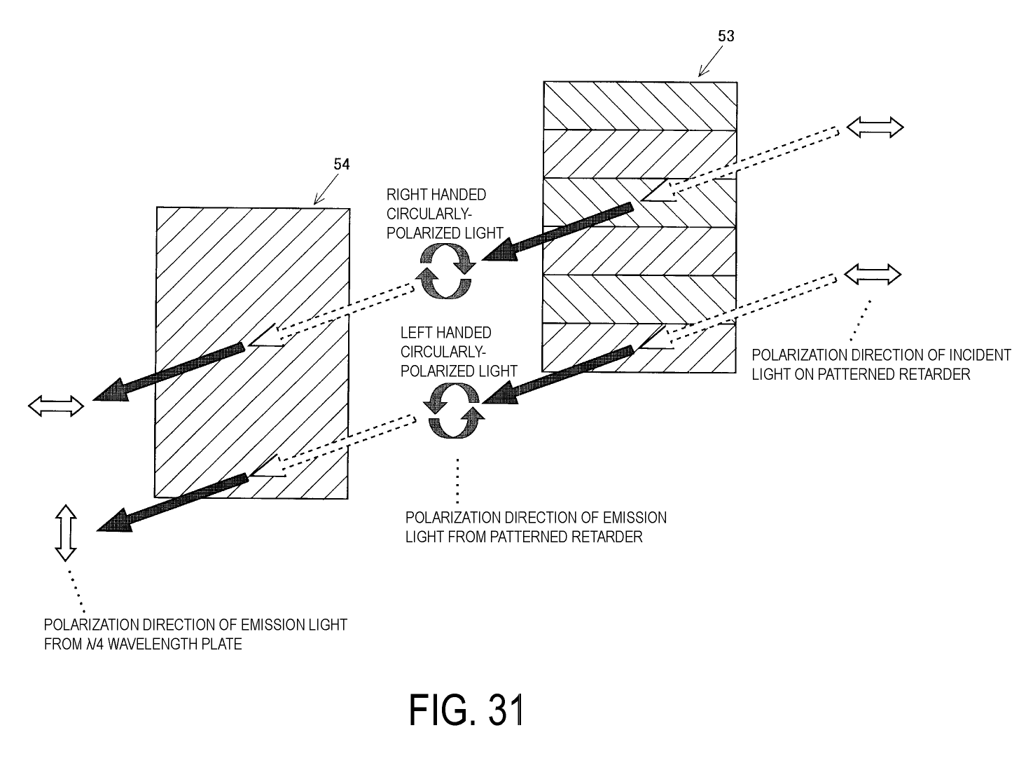

With reference to FIG. 31, how light travels through the patterned retarder 53 and the λ/4 wavelength plate 54 will be described below. In the present embodiment, linearly polarized light having a polarization face parallel to the transmittance axis direction of the second liquid crystal panel emission-side polarizing plate 23 is incident on the patterned retarder 53. As described above, as for the patterned retarder 53 of the present embodiment, the slow axis associated with one of the odd line and the even line forms a positive angle of 45 degrees with respect to the transmittance axis of the second liquid crystal panel emission-side polarizing plate 23, and the slow axis associated with the other one of the odd line and the even line forms a negative angle of 45 degrees with respect to the transmittance axis of the second liquid crystal panel emission-side polarizing plate 23. Accordingly, as illustrated in FIG. 31, emission light from the odd line of the patterned retarder 53 (assumed to be “light of the image A” here) becomes right handed circularly-polarized light (first polarization state), and emission light from the even line of the patterned retarder 53 (assumed to be “light of the image B” here) becomes left handed circularly-polarized light (second polarization state), for example.

As illustrated in FIG. 31, the slow axis direction of the λ/4 wavelength plate 54 is parallel to the slow axis direction associated with the even line of the patterned retarder 53, for example. In this case, right handed circularly-polarized light that is incident on the λ/4 wavelength plate 54 is emitted from the λ/4 wavelength plate 54 as linearly polarized light having a polarization face parallel to the polarization direction of incident light on the patterned retarder 53. In this case, left handed circularly-polarized light that is incident on the λ/4 wavelength plate 54 is emitted from the λ/4 wavelength plate 54 as linearly polarized light having a polarization face orthogonal to the polarization direction of incident light on the patterned retarder 53. With this, two types of linearly polarized light including polarization faces orthogonal to each other (linearly polarized light corresponding to the image A and linearly polarized light corresponding to the image B) are supplied to the first liquid crystal panel 11 inside the first liquid crystal display unit 101, like in the eighth embodiment. The same action as that of the eighth embodiment is performed in the first liquid crystal panel 11.

As discussed above, two kinds of images are alternately displayed spatially in the second liquid crystal panel 12 (mutually different kinds of images are displayed on the odd lines and the even lines respectively); in the first liquid crystal panel 11, the image to be displayed is selected from the two kinds of images on a pixel-by-pixel basis by the applied voltage being controlled for each pixel. With this, a combined image, as selection results across all the pixels, is displayed on the display front face.

### 9.3 Effect

Also in the present embodiment, like the seventh embodiment, a double display capable of suppressing the generation of crosstalk and displaying an image with a depth sensation, a three-dimensional sensation, and the like can be provided while securing sufficient transmittance of the panel on the front face side, without employing high speed drive such as the field sequential system or the like. Further, the structure in which a polarizing plate is not provided on the rear face side of the first liquid crystal panel 11 is employed, whereby an effect of improvement in light utilization efficiency, transmittance and the like, an effect of reduction in manufacturing cost, and the like are obtained,

Like in the fourth embodiment, the influence of surface reflection generated in a space between the first liquid crystal display unit 101 and the second liquid crystal display unit 102 upon display can be reduced because the light in the space between the first liquid crystal display unit 101 and the second liquid crystal display unit 102 is circularly polarized.

Further, regardless of a relationship between the emission polarization direction associated with the second liquid crystal display unit 102 (here, a portion excluding the patterned retarder 53) and the incidence polarization direction associated with the first liquid crystal display unit 101 (here, a portion excluding the λ/4 wavelength plate 54), the emission polarization direction and the incidence polarization direction can be matched by setting the slow axis of each line of the patterned retarder 53 and the slow axis of the λ/4 wavelength plate 54 in appropriate directions.

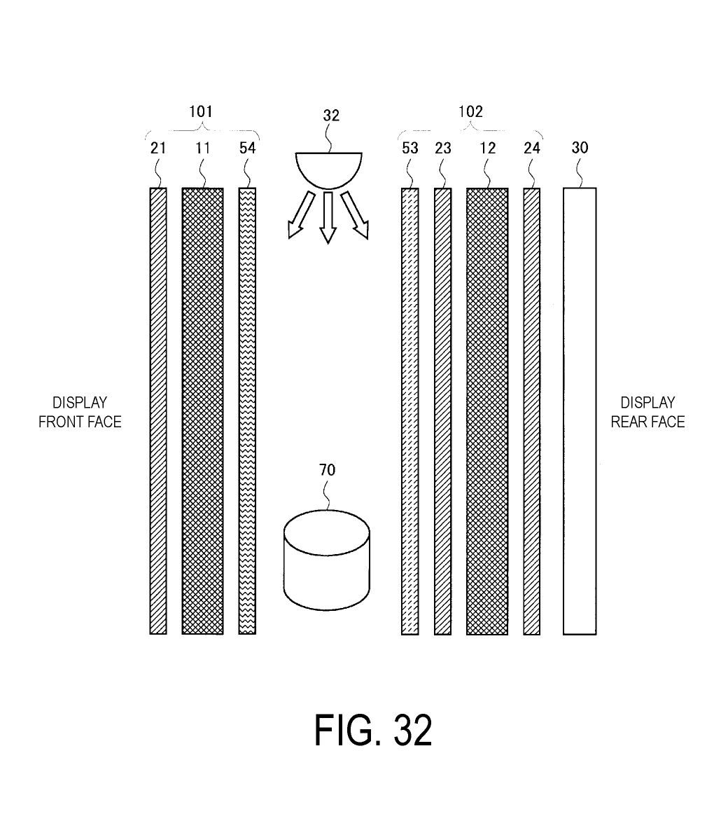

In the case where the object 70 is disposed between the first liquid crystal display unit 101 and the second liquid crystal display unit 102, there arises a fear that the object 70 cannot be seen. As for this, as illustrated in FIG. 32, by employing a structure in which a light source 32 to radiate light toward a space between the first liquid crystal display unit 101 and the second liquid crystal display unit 102 is provided, the emission light from the light source 32 is not blocked by the λ/4 wavelength plate 54. With this, in the case where the object 70 is disposed between the first liquid crystal display unit 101 and the second liquid crystal display unit 102, the object 70 can be seen by a viewer.

### 10. Tenth Embodiment

### 10.1 Structure

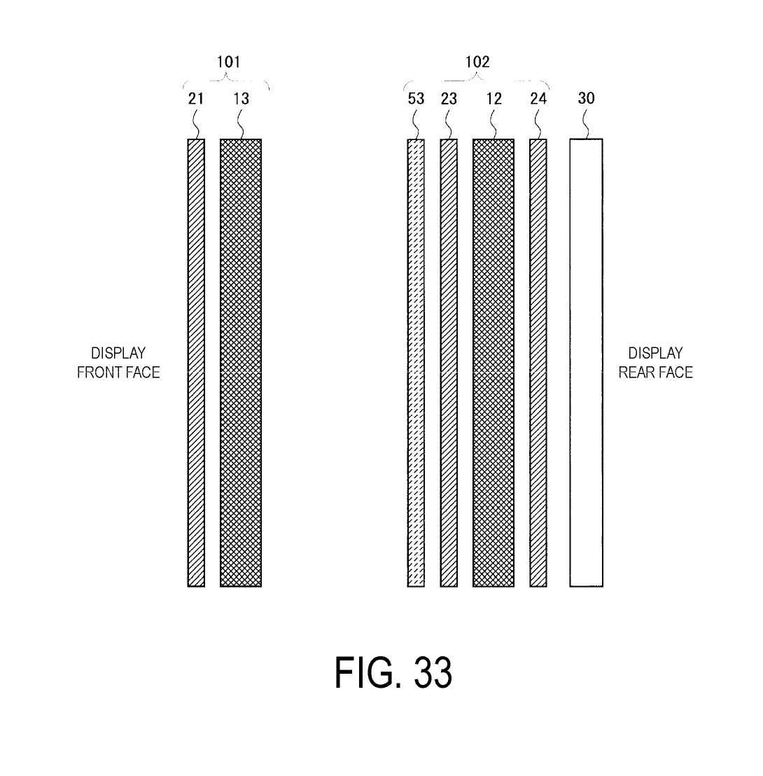

FIG. 33 is a diagram illustrating a structure of an image display device according to the tenth embodiment of the present invention. The stated image display device includes the first liquid crystal display unit 101, the second liquid crystal display unit 102, and the backlight light source 30. The first liquid crystal display unit 101 is constituted of a first liquid crystal panel 13 and the first liquid crystal panel emission-side polarizing plate 21 disposed on a front face side relative to the first liquid crystal panel 13. The second liquid crystal display unit 102 is constituted of the second liquid crystal panel 12, the second liquid crystal panel incidence-side polarizing plate 24 disposed on the rear face side relative to the second liquid crystal panel 12, the second liquid crystal panel emission-side polarizing plate 23 disposed on the froth face side relative to the second liquid crystal panel 12, and a patterned retarder (patterned wavelength plate) 53 as a polarization control element disposed on the front face side relative to the second liquid crystal panel emission-side polarizing plate 23. As discussed above, in the present embodiment, the first liquid crystal panel emission-side polarizing plate 21, the first liquid crystal panel 13, the patterned retarder 53, the second liquid crystal panel emission-side polarizing plate 23, the second liquid crystal panel 12, the second liquid crystal panel incidence-side polarizing plate 24, and the backlight light source 30 are provided in that order from the display front face side toward the display rear face side.

The first liquid crystal panel 13 of the present embodiment, different from the first liquid crystal panel 11 of the first to ninth embodiments, functions as a λ/4 wavelength plate capable of controlling the slow axis direction for each pixel by the applied voltage. That is, an active retarder (variable wavelength plate), like the active retarder disclosed in JP 2013-235208 A, for example, is employed for the first liquid crystal panel 13. The first liquid crystal panel 13 (active retarder) is constituted so that the slow axis direction at a pixel to which a voltage (a predetermine magnitude of voltage) is applied is orthogonal to the slow axis direction at a pixel to which the voltage is not applied.

### 10.2 Action

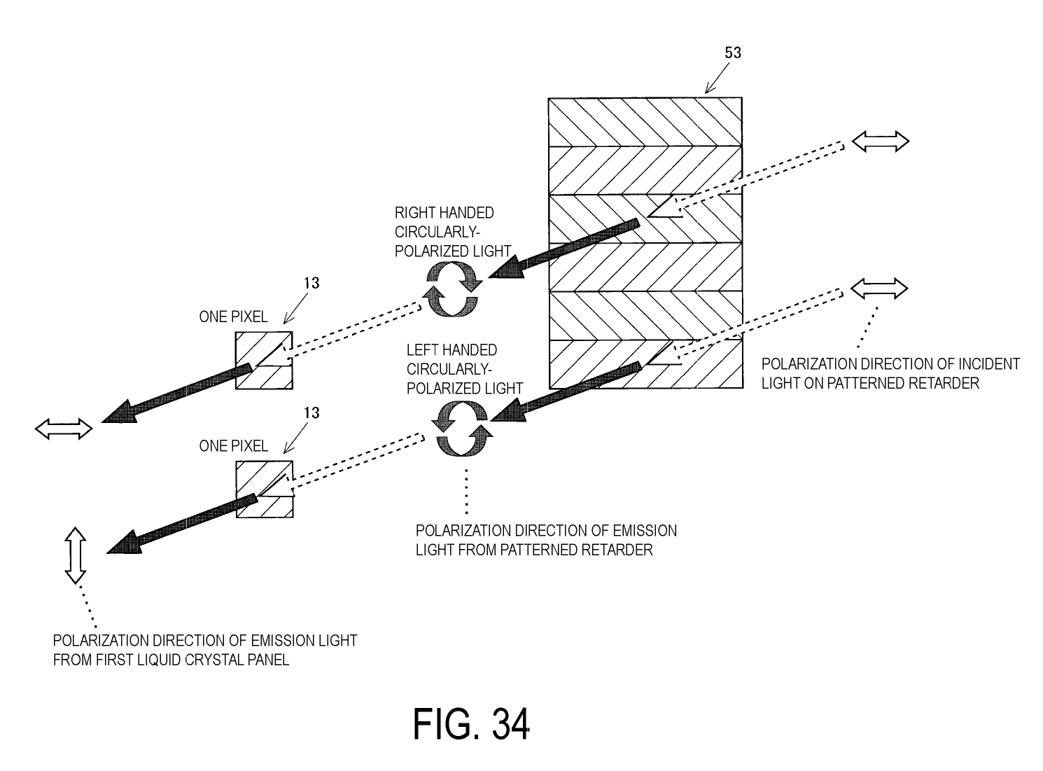

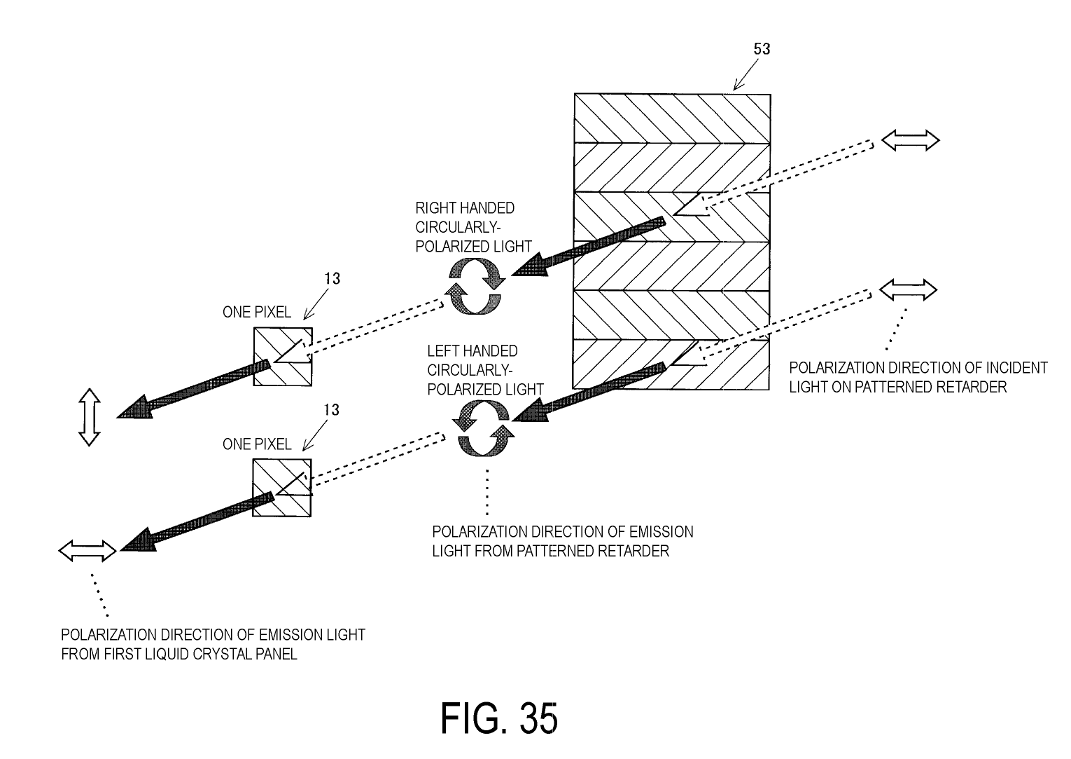

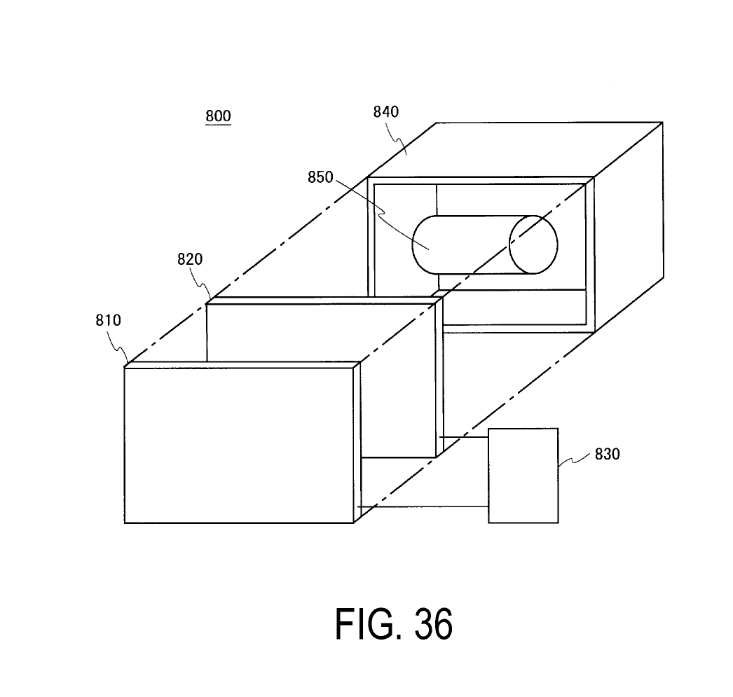

How light travels through the patterned retarder 53 and the first liquid crystal panel 13 (active retarder) will be described below with reference to FIGS. 34 and 35. In the present embodiment, like the ninth embodiment, emission light from the odd line of the patterned retarder 53 (assumed to be “light of the image A” here) becomes right handed circularly-polarized light (first polarization state), and emission light from the even line of the patterned retarder 53 (assumed to be “light of the image B” here) becomes left handed circularly-polarized light (second polarization state), for example.

As for the first liquid crystal panel 13 (active retarder), it is assumed here that the slow axis direction at a pixel to which a voltage is applied is parallel to the slow axis direction associated with the even line of the patterned retarder 53 while the slow axis direction at a pixel to which the voltage is not applied is parallel to the slow axis direction associated with the odd line of the patterned retarder 53.

On the above assumption, at the pixel to which the voltage is not applied in the first liquid crystal panel 13, light travels as described below (see FIG. 34). Right handed circularly-polarized light that is incident on the first liquid crystal panel 13 is emitted from the first liquid crystal panel 13 as linearly polarized light having a polarization face which is parallel to the polarization direction of incident light on the patterned retarder 53. Left handed circularly-polarized light that is incident on the first liquid crystal panel 13 is emitted from the first liquid crystal panel 13 as linearly polarized light having a polarization face which is orthogonal to the polarization direction of incident light on the patterned retarder 53.

Further, at the pixel to which a voltage (a predetermine magnitude of voltage) is applied in the first liquid crystal panel 13, light travels as described below (see FIG. 35). Right handed circularly-polarized light that is incident on the first liquid crystal panel 13 is emitted from the first liquid crystal panel 13 as linearly polarized light having a polarization face which is orthogonal to the polarization direction of incident light on the patterned retarder 53. Meanwhile, left handed circularly-polarized light that is incident on the first liquid crystal panel 13 is emitted from the first liquid crystal panel 13 as linearly polarized light having a polarization face which is parallel to the polarization direction of incident light on the patterned retarder 53.

In a case where the transmittance axis of the first liquid crystal panel emission-side polarizing plate 21 is parallel to the transmittance axis of the second liquid crystal panel emission-side polarizing plate 23, the pixel to which the voltage is applied in the first liquid crystal panel 13 displays the image A while the pixel to which the voltage is not applied in the first liquid crystal panel 13 displays the image B. On the other hand, in a case where the transmittance axis of the first liquid crystal panel emission-side polarizing plate 21 is orthogonal to the transmittance axis of the second liquid crystal panel emission-side polarizing plate 23, the pixel to which the voltage is applied in the first liquid crystal panel 13 displays the image B while the pixel to which the voltage is not applied in the first liquid crystal panel 13 displays the image A

In the manner discussed above, like in the seventh embodiment, two kinds of images are alternately displayed spatially in the second liquid crystal panel 12 (mutually different kinds of images are displayed on the odd lines and the even lines respectively); in the first liquid crystal panel 11, the image to be displayed is selected from the two kinds of images on a pixel-by-pixel basis by the applied voltage being controlled for each pixel. With this, a combined image, as selection results across all the pixels, is displayed on the display front face.

### 10.3 Effect

According to the present embodiment, the same effect as that of the ninth embodiment can be obtained with the image display device having a relatively simple structure.

### 11. Others

The present invention is not limited to the aforementioned embodiments, and various modifications can be made without departing from the scope of the present invention. For example, in the above-described seventh to tenth embodiments, an image in an intermediate state in which two kinds of images are mixed may he displayed by allowing 50% of light of each of the two kinds of images to pass through at each pixel. In other words, a display ratio of each of the two kinds of images may be determined on a pixel-by-pixel basis in the first liquid crystal panels 11 and 13.

### REFERENCE SIGNS LIST

11 First liquid crystal panel
12 Second liquid crystal panel
13 First liquid crystal panel (active retarder)
21 First liquid crystal panel emission-side polarizing plate
22 First liquid crystal panel incidence-side polarizing plate
23 Second liquid crystal panel emission-side polarizing plate
24 Second liquid crystal panel incidence-side polarizing plate
30 Backlight light source
41 First λ/4 wavelength plate
42 Second λ/4 wavelength plate
45 λ/2 wavelength plate
48 Double refraction film
51 Patterned polarizer
52 Patterned retarder (a wavelength plate of a structure in which two types of λ/2 wavelength plates are alternately disposed line by line)
53 Patterned retarder (a wavelength plate of a structure in which two types of λ/4 wavelength plates arc alternately disposed line by line)
54 λ/4 wavelength plate
101 First liquid crystal display unit
102 Second liquid crystal display unit

1. An image display device comprising:
a first liquid crystal display unit disposed on a front face side and including a first liquid crystal panel;
a second liquid crystal display unit disposed on a rear face side and including a second liquid crystal panel; and
a backlight light source disposed on the rear face side relative to the second liquid crystal display unit,
wherein a plurality of kinds of images are displayed in the second liquid crystal panel, and
in the first liquid crystal panel, an image to be displayed is selected from the plurality of kinds of images on a pixel-by-pixel basis, or a display ratio is determined for each of the plurality of kinds of images.

2. The image display device according to claim 1,
wherein a first image and a second image, as the plurality of kinds of images, are alternately displayed temporally in the second liquid crystal panel, and
in the first liquid crystal panel, an applied voltage to each of the pixels is controlled such that a pixel to display the first image is set to an opened state while a pixel to display the second image is set to a closed state when the first image is displayed in the second liquid crystal panel, and such that a pixel to display the first image is set to the closed state while a pixel to display the second image is set to the opened state when the second image is displayed in the second liquid crystal panel.

3. The image display device according to claim 2,
wherein the first liquid crystal display unit includes the first liquid crystal panel and a first liquid crystal panel emission-side polarizing plate disposed on the front face side relative to the first liquid crystal panel, and
the second liquid crystal display unit includes the second liquid crystal panel, a second liquid crystal panel incidence-side polarizing plate disposed on the rear face side relative to the second liquid crystal panel, and a second liquid crystal panel emission-side polarizing plate disposed on the front face side relative to the second liquid crystal panel.

4. The image display device according to claim 2,
wherein the first liquid crystal display unit includes the first liquid crystal panel, a first liquid crystal panel incidence-side polarizing plate disposed on the rear face side relative to the first liquid crystal panel, and a first liquid crystal panel emission-side polarizing plate disposed on the front face side relative to the first liquid crystal panel, and
the second liquid crystal display unit includes the second liquid crystal panel, and a second liquid crystal panel incidence-side polarizing plate disposed on the rear face side relative to the second liquid crystal panel.

5. The image display device according to claim 2,
wherein the first liquid crystal display unit includes the first liquid crystal panel, a first liquid crystal panel incidence-side polarizing plate disposed on the rear face side relative to the first liquid, crystal panel, and a first liquid crystal panel emission-side polarizing plate disposed on the front face side relative to the first liquid crystal panel, and
the second liquid crystal display unit includes the second liquid crystal panel, a second liquid crystal panel incidence-side polarizing plate disposed on the rear face side relative to the second liquid crystal panel, and a second liquid crystal panel emission-side polarizing plate disposed on the front face side relative to the second liquid crystal panel.

6. The image display device according to claim 3, further comprising:
two λ/4 wavelength plates disposed at a predetermined interval in a region between the first liquid crystal display unit and the second liquid crystal display unit.

7. The image display device according to claim 3, further comprising:
a λ/2 wavelength plate provided in a region between the first liquid crystal display unit and the second liquid crystal display unit,
wherein, in a case where a polarization direction of light emitted from the front face side of the second liquid crystal display unit is defined as a first direction, and a polarization direction of light incident on the first liquid crystal display unit when a desired image is displayed in the first liquid crystal display unit is defined as a second direction, an angle formed by the first direction and a slow axis direction of the λ/2 wavelength plate and an angle formed by the second direction and the slow axis direction of the λ/2 wavelength plate match each other.

8. The image display device according to claim 5, further comprising:
a double refraction film provided in a region between the first liquid crystal display unit and the second liquid crystal display unit.

9. The image display device according to claim 1,
wherein the first image and the second image, as the plurality of kinds of images, are alternately displayed spatially in the second liquid crystal panel,
the second liquid crystal display unit includes a polarization control element disposed on the front face side relative to the second liquid crystal panel, and sets a polarization state of light of the first image to a first polarization state and also sets a polarization state of light of the second image to a second polarization state, and
in the first liquid crystal panel, an applied voltage to each of the pixels is controlled such that a pixel to display the first image blocks the light in the second polarization state and allows the light in the first polarization state to pass through, and such that a pixel to display the second image blocks the light in the first polarization state and allows the light in the second polarization state to pass through.

10. The image display device according to claim 9,
wherein the polarization control element is a patterned polarizing plate including a structure in which two types of polarizing plates with transmittance axes orthogonal to each other are alternately disposed in striped form,
the first liquid crystal display unit includes the first liquid crystal panel and a first liquid crystal panel emission-side polarizing plate disposed on the front face side relative to the first liquid crystal panel, and
the second liquid crystal display unit includes the second liquid crystal panel, a second liquid crystal panel incidence-side polarizing plate disposed on the rear face side relative to the second liquid crystal panel, a second liquid crystal panel emission-side polarizing plate disposed on the front face side relative to the second liquid crystal panel, and the patterned polarizing plate disposed on the front face side relative to the second liquid crystal panel emission-side polarizing plate.

11. The image display device according to claim 9,
wherein the polarization control element is a patterned wavelength plate including a structure which two types of λ/2 wavelength plates with slow axes in mutually different directions are alternately disposed in striped form such that two types of light with polarization directions orthogonal to each other are alternately emitted in striped form, the first liquid crystal display unit includes the first liquid crystal panel and a first liquid crystal panel emission-side polarizing plate disposed on the front face side relative to the first liquid crystal panel, and
the second liquid crystal display unit includes the second liquid crystal panel, a second liquid crystal panel incidence-side polarizing plate disposed on the rear face side relative to the second liquid crystal panel, a second liquid crystal panel emission-side polarizing plate disposed on the front face side relative to the second liquid crystal panel, and the patterned wavelength plate disposed on the front face side relative to the second liquid crystal panel emission-side polarizing plate.

12. The image display device according to claim 9,
wherein the polarization control element causes light of the first image and light of the second image to be circularly polarized rotating in opposite directions to each other.

13. The image display device according to claim 12,
wherein the polarization control element is a patterned wavelength plate including a structure in which two types of λ/4 wavelength plates with slow axes in mutually different directions are alternately disposed in striped form such that right handed circularly-polarized light and left handed circularly-polarized light are alternately emitted in striped form,
the first liquid crystal display unit includes the first liquid crystal panel, a λ/4 wavelength plate disposed on the rear face side relative to the first liquid crystal panel and including a slow axis in the same direction as the slow axis of one of the above two types of λ/4 wavelength plates, and a first liquid crystal panel emission-side polarizing plate disposed on the front face side relative to the first liquid crystal panel, and
the second liquid crystal display unit includes the second liquid crystal panel, a second liquid crystal panel incidence-side polarizing plate disposed on the rear face side relative to the second liquid crystal panel, a second liquid crystal panel emission-side polarizing plate disposed on the front face side relative to the second liquid crystal panel, and the patterned wavelength plate disposed on the front face side relative to the second liquid crystal panel emission-side polarizing plate.

14. The image display device according to claim 12,
wherein the polarization control element is a patterned wavelength plate including a structure in which two types of λ/4 wavelength plates with slow axes in mutually different directions are alternately disposed in striped form such that right handed circularly-polarized light and left handed circularly-polarized light are alternately emitted in striped form,
the first liquid crystal display unit is constituted of the first liquid crystal panel and a first liquid crystal panel emission-side polarizing plate disposed on the front face side relative to the first liquid crystal panel,
the second liquid crystal display unit is constituted of the second liquid crystal panel, a second liquid crystal panel incidence-side polarizing plate disposed on the rear face side relative to the second liquid crystal panel, a second liquid crystal panel emission-side polarizing plate disposed on the front face side relative to the second liquid crystal panel, and the patterned wavelength plate disposed on the front face side relative to the second liquid crystal panel emission-side polarizing plate, and
the first liquid crystal panel functions as a variable wavelength plate configured to control the slow axis direction by the applied voltage on a pixel-by-pixel basis.

15. The image display device according to claim 1,
wherein, of the first liquid crystal panel and the second liquid crystal panel, only the second liquid crystal panel includes a color filter.
